(19) United States
(12) Patent Application Publication
(10) Pub. No.: US 2018/0069726 A1
(43) Pub. Date: Mar. 8, 2018

(54) COMMUNICATION DEVICE, COMMUNICATION METHOD, COMMUNICATION SYSTEM, AND COMPUTER PROGRAM PRODUCT

(71) Applicants: Kohki OHHIRA, Tokyo (JP); Masaru KURODA, Tokyo (JP); Shintaro KAWAMURA, Kanagawa (JP); Ryusuke MAYUZUMI, Kanagawa (JP); Hiroki SUGINO, Kanagawa (JP)

(72) Inventors: Kohki OHHIRA, Tokyo (JP); Masaru KURODA, Tokyo (JP); Shintaro KAWAMURA, Kanagawa (JP); Ryusuke MAYUZUMI, Kanagawa (JP); Hiroki SUGINO, Kanagawa (JP)

(21) Appl. No.: 15/551,173

(22) PCT Filed: Feb. 29, 2016
(86) PCT No.: PCT/JP2016/001081

§ 371 Date: Aug. 15, 2017

(30) Foreign Application Priority Data
Mar. 2, 2015 (JP) 2015-040357
Dec. 2, 2015 (JP) 2015-235991

(51) Int. Cl. H04L 12/46; H04L 12/64; H04L 29/12

(52) U.S. Cl. CPC H04L 12/46; H04L 12/6418; H04W 84/12; H04L 61/6059; H04L 61/2015

(57) ABSTRACT

A communication device includes: a first communication unit that performs wireless communication through a first communication scheme; a second communication unit that performs wireless communication through a second communication scheme in a second communication range; and a connecting module configured to establish a communication connection that forms an external network. The second communication unit transmits setup information for establishing a communication line through the first communication scheme. The first communication unit performs wireless communication through the first communication scheme with another communication device that has received the setup information. The connecting module forms an exclusive external network to establish a communication connection with an external device disposed in a communication system that exists at a physically different place.

### TECHNICAL FIELD

The present invention relates to a communication device, a communication method, a communication system, and a computer program product.

### BACKGROUND ART

Patent Literature 1 (Japanese Laid-open Patent Publication No. 2002-351766) discloses a setup file transmission system intended for facilitation of setup of a wireless LAN (local area network). With this setup file transmission system, when a distance between a personal computer device of a wireless LAN provider and a user terminal is equal to or less than a predetermined distance, wireless LAN setup information is transmitted to the user terminal via a server device and the personal computer of the wireless LAN provider through Bluetooth (registered trademark) communication. The user terminal performs the setup of the wireless LAN for the host device using the received wireless LAN setup information. This facilitates the wireless LAN setup.

### SUMMARY OF INVENTION

### Technical Problem

When small-scale networks such as wireless LANs exist at places physically apart from each other, enhanced convenience can be achieved, if devices in different wireless LANs can communicate with each other. Hence, for example, when no printer devices exist in a first wireless LAN, a smart device disposed in the first LAN may operate a printer device disposed in a second wireless LAN to perform printing on the printer device disposed in the second wireless LAN.

Ensuring network security among different wireless LANs is, however, important in such a type of communication.

There is a need to enable communication with enhanced security between devices disposed in communication systems that are physically apart from each other.

### Solution to Problem

To solve the foregoing problem, an aspect of the present invention provides a communication device that includes: a first communication unit that performs wireless communication through a first communication scheme; a second communication unit that performs wireless communication through a second communication scheme in a second communication range; and a connecting module configured to establish a communication connection that forms an external network. The second communication unit transmits setup information for establishing a communication line through the first communication scheme. The first communication unit performs wireless communication through the first communication scheme with another communication device that has received the setup information. The connecting module forms an exclusive external network to thereby establish a communication connection with an external device disposed in a communication system that exists at a physically different place.

### Advantageous Effect of Invention

An embodiment provides an effect that communication with security between devices disposed in communication systems that are physically apart from each other is enabled.

### BRIEF DESCRIPTION OF DRAWINGS

FIG. 1 is a system configuration diagram illustrating a basic configuration of a wireless LAN communication system.

FIG. 2 is a hardware configuration diagram illustrating a communication range limiting device disposed in the wireless LAN communication system that is a basic configuration.

FIG. 3 is a hardware configuration diagram illustrating a smartphone device disposed in the wireless LAN communication system that is the basic configuration.

FIG. 4 is a hardware configuration diagram illustrating a printer device disposed in the wireless LAN communication system that is the basic configuration.

FIG. 5 is a hardware configuration diagram illustrating a projector device disposed in the wireless LAN communication system that is the basic configuration.

FIG. 6 is a functional block diagram of the communication range limiting device disposed in the wireless LAN communication system that is the basic configuration.

FIG. 7 is a functional block diagram of the smartphone disposed in the wireless LAN communication system that is the basic configuration.

FIG. 8 is a functional block diagram of the printer device disposed in the wireless LAN communication system that is the basic configuration.

FIG. 9 is a sequence diagram illustrating that a smartphone that has moved into a BLE communication area within a wireless LAN communication area establishes a wireless LAN communication line in the wireless LAN communication system that is the basic configuration.

FIG. 10 is a sequence diagram illustrating that a printer device disposed in the BLE communication area within the wireless LAN communication area establishes a wireless LAN communication line in the wireless LAN communication system that is the basic configuration.

FIG. 11 is a flowchart illustrating that a smartphone connected to a wireless LAN remotely controls and causes a printer device to produce a printed matter in the wireless LAN communication system that is the basic configuration.

FIG. 12 is a sequence diagram illustrating that a wireless LAN communication line (and a BLE communication line) is disconnected when a smartphone connected in the BLE communication area to a printer device through a wireless LAN moves out of the BLE communication area in the wireless LAN communication system that is the basic configuration.

FIG. 13 is a system configuration diagram illustrating an exemplary case in which at least part of the BLE communication area is disposed outside the wireless LAN communication area in the wireless LAN communication system that is the basic configuration.

FIG. 14 is a system configuration diagram of a wireless LAN communication system in an embodiment.

FIG. 15 is a diagram illustrating an exemplary VPN connection established between wireless LAN communication systems in the embodiment.

FIG. 16 is a hardware configuration diagram of the communication range limiting device included in the wireless LAN communication system in the embodiment.

FIG. 17 is a hardware configuration diagram of the smartphone included in the wireless LAN communication system in the embodiment.

FIG. 18 is a functional block diagram of the communication range limiting device disposed in the wireless LAN communication system in the embodiment.

FIG. 19 is a functional block diagram of the smartphone disposed in the wireless LAN communication system in the embodiment.

FIG. 20 is a schematic diagram illustrating a first list disposed in the communication range limiting device of the wireless LAN communication system in the embodiment.

FIG. 21 is a schematic diagram illustrating a second list disposed in the communication range limiting device of the wireless LAN communication system in the embodiment.

FIG. 22 is a flowchart for illustrating operations performed to set an IPv6 address upon starting of the wireless LAN communication system in the embodiment.

FIG. 23 is a flowchart illustrating steps to be performed for establishing a wireless LAN communication line connection in a smart device that has moved into the BLE communication area of the wireless LAN communication system in the embodiment.

FIG. 24 is a flowchart illustrating steps to be performed for establishing a wireless LAN communication line connection in a peripheral device that has moved into the BLE communication area of the wireless LAN communication system in the embodiment.

FIG. 25 is a flowchart illustrating steps for performing printing by the smartphone of the wireless LAN communication system in the embodiment on a printer device selected on a basis of a transfer list.

FIG. 26 is a flowchart illustrating steps of an operation to be performed to disconnect a wireless LAN communication line when a smart device and a peripheral device connected to the wireless LAN communication line move out of the BLE communication area in the wireless LAN communication system in the embodiment.

FIG. 27 is a flowchart illustrating an operation for establishing a VPN connection between wireless LAN communication systems connected to each other in the embodiment.

FIG. 28 is a flowchart illustrating an operation for disconnecting the VPN connection between the wireless LAN communication systems connected to each other in the embodiment.

FIG. 29 is a flowchart illustrating an operation for preparing a controlled object list intended for operating devices of first and second wireless LAN communication systems using a device of the first wireless LAN communication system in an environment in which the first and second wireless LAN communication systems in the embodiment are connected by VPN connection.

FIG. 30 is a diagram for illustrating a configuration of the controlled object list used in the wireless LAN communication system in the embodiment.

FIG. 31 is a flowchart illustrating steps for operating, in accordance with the controlled object list, devices of first and second wireless LAN communication systems in the wireless LAN communication system in the embodiment.

### DESCRIPTION OF EMBODIMENTS

The following details, with reference to the accompanying drawings, a wireless local area network (LAN) communication system according to embodiments to which the present invention is applied.

### Basic Configuration

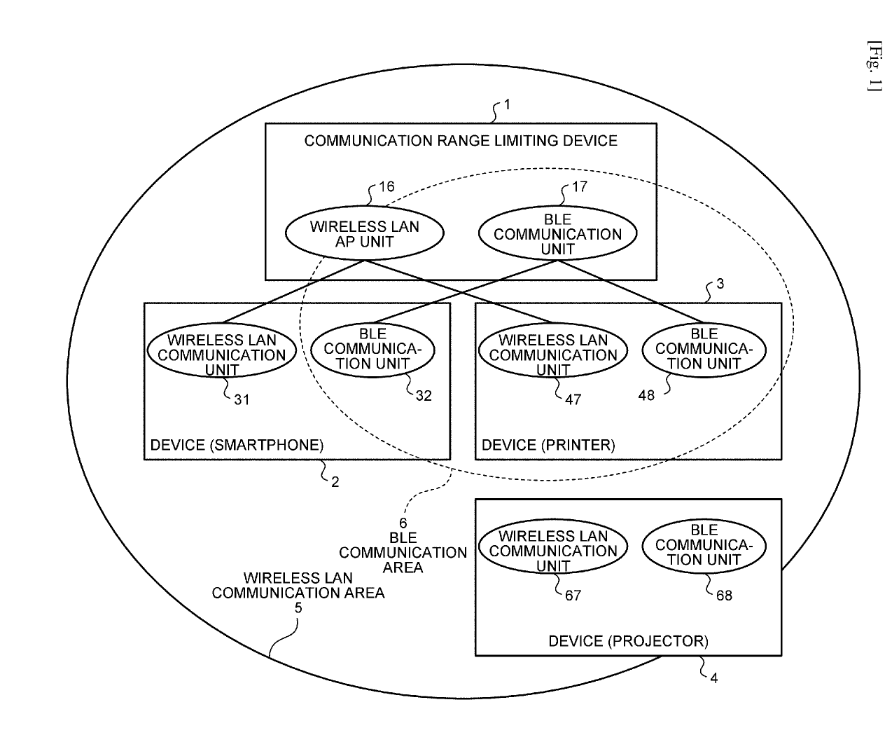

The following describes a basic configuration of the wireless LAN communication system according to the embodiments to be described hereunder. FIG. 1 is a system configuration diagram illustrating the basic configuration of the wireless LAN communication system. As illustrated in FIG. 1, the wireless LAN communication system includes a communication range limiting device 1, a smartphone 2 as a first device, a printer device 3 as a second device, and a projector device 4 as a third device. It is noted that each device illustrated in FIG. 1 represents only an example and may be replaced by any other device that has a communication function to be described later. For example, a tablet terminal device, a portable gaming machine, a notebook personal computer, or any other portable communication device may be used in place of the smartphone 2.

### Basic Configuration of Communication Range Limiting Device

The communication range limiting device 1 forms an access point for a wireless LAN, such as a wireless LAN router. The communication range limiting device 1 forms, as an exemplary local area network, a wireless LAN communication area 5 indicated by the solid-line ellipse in FIG. 1. The communication range limiting device 1 enables communication of each device only in an area narrower than the wireless LAN communication area 5 within the wireless LAN communication area 5. For example, the communication range control device 1 enables communication of each device only in a personal area network (PAN) that is narrower than the wireless LAN communication area 5 within the wireless LAN communication area 5.

Exemplarily, a Bluetooth (registered trademark) PAN that performs Bluetooth (registered trademark) Low Energy (BLE) communication consuming ultra-low electric power may be used as the personal area network. In FIG. 1, a communication range indicated by the dotted-line ellipse is a BLE communication area 6 by the Bluetooth (registered trademark) PAN. The following description assumes that the personal area network is the Bluetooth PAN. Nonetheless, non-contact wireless communication (Near Field Communications (NFC)), milliwave wireless communication, QR code (registered trademark), visible light, environmental sound, and ultrasonic waves may, for example, be used instead of the Bluetooth.

### Basic Hardware Configuration of Communication Range Limiting Device

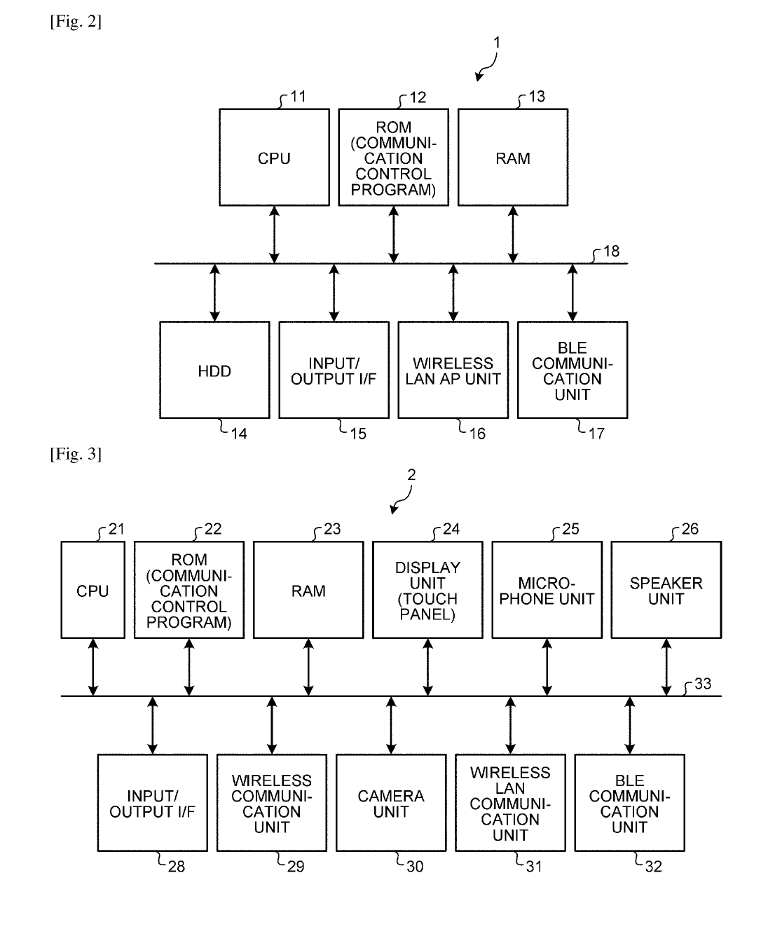

FIG. 2 illustrates a basic hardware configuration of the communication range limiting device 1. As illustrated in FIG. 2, the communication range limiting device 1 includes a central processing unit (CPU) 11, a read only memory (ROM) 12, a random access memory (RAM) 13, a hard disk drive (HDD) 14, an input/output interface (input/output UF) 15, a wireless LAN AP unit 16 (AP stands for access point), and a BLE communication unit 17. The elements from the CPU 11 to the BLE communication unit 17 are connected to each other via a bus line 18.

The ROM 12 stores a communication control program for enabling communication of each device only in the BLE communication area 6 within the wireless LAN communication area 5. The communication control program may be stored in the RAM 13, the HDD 14, or other storage unit. The CPU 11 operates in accordance with the communication control program to thereby control the wireless LAN AP unit 16 and the BLE communication unit 17, controlling to enable communication of each device only in the BLE communication area 6 within the wireless LAN communication area 5.

In FIGS. 1 and 2, the communication range limiting device 1 is illustrated as a standalone device. The communication range limiting device 1 may, however, be incorporated in each device, for example, in a printer device or a multifunction peripheral (MFP).

### Basic Hardware Configuration of Smartphone

FIG. 3 illustrates a hardware configuration of the smartphone 2. As illustrated in FIG. 3, the smartphone 2 includes a CPU 21, a ROM 22, a RAM 23, a display unit 24, a microphone unit 25, and a speaker unit 26. The smartphone 2 further includes an input/output I/F 28, a wireless communication unit 29, a camera unit 30, a wireless LAN communication unit 31, and a BLE communication unit 32. The elements from the CPU 21 to the BLE communication unit 32 are connected to each other via a bus line 33.

The ROM 22 stores a communication control program for enabling communication of each device only in the BLE communication area 6 within the wireless LAN communication area 5. The communication control program may be stored in the RAM 23 or other storage unit. The CPU 21 operates in accordance with the communication control program to thereby control the wireless LAN communication unit 31 and the BLE communication unit 32. The CPU 21 thereby enables BLE communication in the BLE communication area 6 within the wireless LAN communication area 5.

The display unit 24 integrates a touch panel formed of a transparent electrode with a display panel to thereby form what is called a touch panel-mounted display unit. The wireless communication unit 29 performs communication of, for example, telephone and e-mail via a wireless base station operating on a predetermined carrier.

### Basic Hardware Configuration of Printer Device

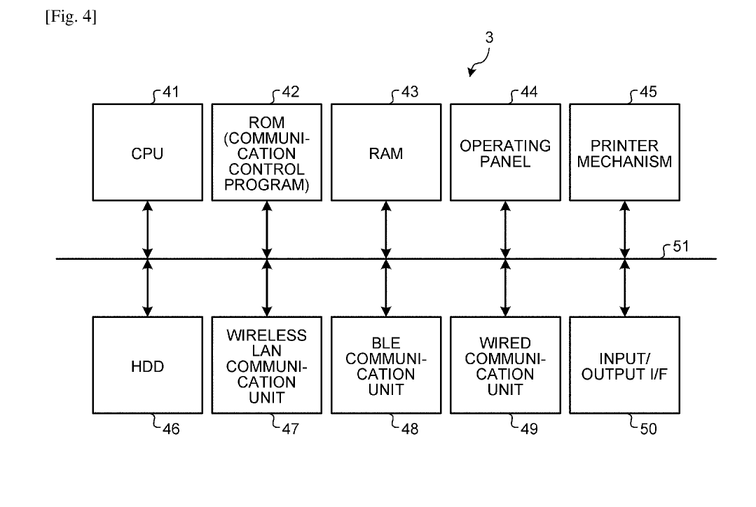

FIG. 4 illustrates a basic hardware configuration of the printer device 3. As illustrated in FIG. 4, the printer device 3 includes a CPU 41, a ROM 42, a RAM 43, an operating panel 44, and a printer mechanism 45. The printer device 3 further includes an HDD 46, a wireless LAN communication unit 47, a BLE communication unit 48, a wired communication unit 49, and an input/output I/F 50. The elements from the CPU 41 to the input/output I/F 50 are connected to each other via a bus line 51.

The ROM 42 stores a communication control program for enabling communication of each device only in the BLE communication area 6 within the wireless LAN communication area 5. The communication control program may be stored in the RAM 43, the HDD 46, or other storage unit. The CPU 41 operates in accordance with the communication control program to thereby control the wireless LAN communication unit 47 and the BLE communication unit 48. The CPU 41 thereby enables BLE communication in the BLE communication area 6 within the wireless LAN communication area 5. Additionally, the printer mechanism 45 performs printing of, for example, images and texts, in accordance with a print setup specified from the smartphone 2.

### Basic Hardware Configuration of Projector Device

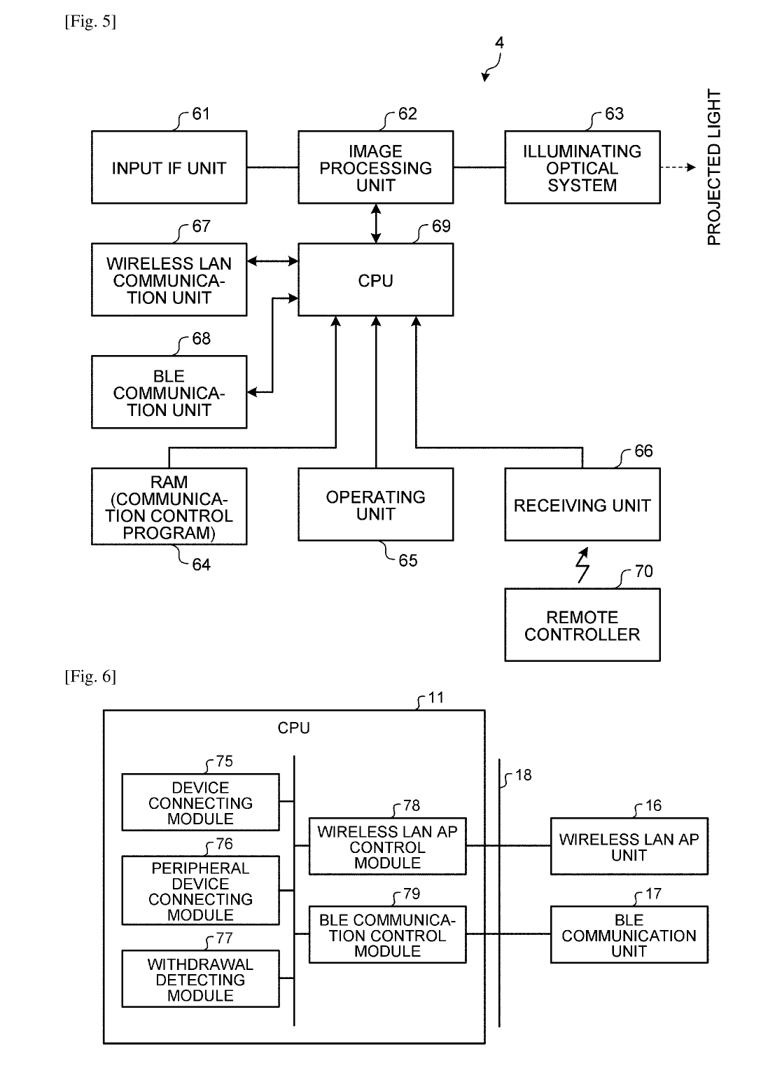

FIG. 5 illustrates a basic hardware configuration of the projector device 4. As illustrated in FIG. 5, the projector device 4 includes an input interface unit (input IF unit) 61, an image processing unit 62, an illuminating optical system 63, a RAM 64, and an operating unit 65. The projector device 4 further includes a receiving unit 66 that receives commands from a remote controller 70 through infrared communication, a wireless LAN communication unit 67, a BLE communication unit 68, and a CPU 69.

The projector device 4 receives image information that corresponds to a projected image supplied to the input IF unit 61 thereof. The image information is subjected to predetermined image processing including distortion correction performed by the image processing unit 62 before being projected onto, for example, a screen by the illuminating optical system 63.

The RAM 64 stores a communication control program for enabling communication of each device only in the BLE communication area 6 within the wireless LAN communication area 5. The communication control program may be stored in a ROM, a HDD, or other storage unit. The CPU 69 operates in accordance with the communication control program to thereby control the wireless LAN communication unit 67 and the BLE communication unit 68. The CPU 69 thereby enables BLE communication in the BLE communication area 6 within the wireless LAN communication area 5.

### Basic Software Configuration of Communication Range Limiting Device

FIG. 6 is a block diagram illustrating functions achieved by the CPU 11 of the communication range limiting device 1 when the CPU 11 operates in accordance with the communication control program. As illustrated in FIG. 6, the CPU 11 of the communication range limiting device 1 executes the communication control program to thereby function as a device connecting module 75, a peripheral device connecting module 76, a withdrawal detecting module 77, a wireless LAN AP control module 78, and a BLE communication control module 79.

It is noted that the following description of this example assumes that the elements from the device connecting module 75 to the BLE communication control module 79 are achieved as software functions by the communication control program. The elements from the device connecting module 75 to the BLE communication control module 79 may nonetheless be achieved in part or in whole by an integrated circuit (IC) or by hardware.

The communication control program of the communication range limiting device 1 may be recorded and provided in a computer-readable recording medium such as a CD-ROM and a flexible disk (FD) as an installable or executable file. The communication control program of the communication range limiting device 1 may even be recorded and provided in a computer-readable recording medium such as a CD-R, a digital versatile disk (DVD), a Blu-ray disc (registered trademark), and a semi-conductor memory. The communication control program of the communication range limiting device 1 may still be provided by being installed via a network such as the Internet. The communication control program of the communication range limiting device 1 may still be embedded and provided in a ROM of a device, for example.

### Basic Software Configuration of Smartphone

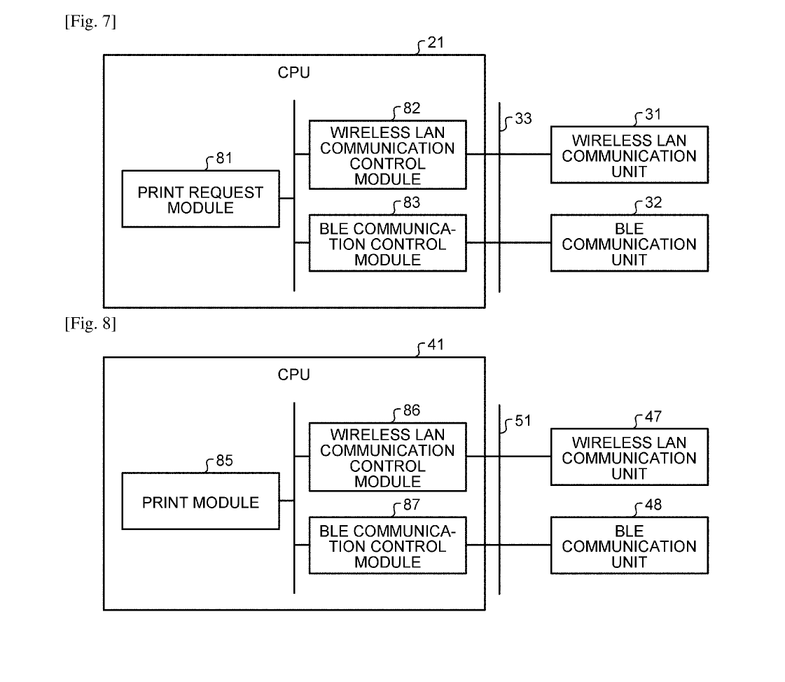

FIG. 7 is a block diagram illustrating functions achieved by the CPU 21 of the smartphone 2 when the CPU 21 operates in accordance with the communication control program. As illustrated in FIG. 7, the CPU 21 of the smartphone 2 operates in accordance with the communication control program to thereby each function as a print request module 81, a wireless LAN communication control module 82, and a BLE communication control module 83. The print request module 81 achieves a function of remotely operating the printer device 3 through BLE communication to thereby cause the printer device 3 to print a desired image or text, for example.

It is noted that the following description of this example assumes that the elements from the print request module 81 to the BLE communication control module 83 are achieved as software functions by the communication control program. The elements from print request module 81 to the BLE communication control module 83 may nonetheless be achieved in part or in whole by an integrated circuit (IC) or by hardware.

The communication control program of the smartphone 2 may be recorded and provided in a computer-readable recording medium such as a CD-ROM and a flexible disk (FD) as an installable or executable file. The communication control program of the smartphone 2 may even be recorded and provided in a computer-readable recording medium such as a CD-R, a digital versatile disk (DVD), a Blu-ray disc (registered trademark), and a semiconductor memory. The communication control program of the smartphone 2 may still be provided by being installed via a network such as the Internet. The communication control program of the smartphone 2 may still be embedded and provided in a ROM of a device, for example.

### Basic Software Configuration of Printer Device

FIG. 8 is a block diagram illustrating functions achieved by the CPU 41 of the printer device 3 when the CPU 41 operates in accordance with the communication control program. As illustrated in FIG. 8, the CPU 41 of the printer device 3 operates in accordance with the communication control program to thereby function as a print module 85, a wireless LAN communication control module 86, and a BLE communication control module 87. The print module 85 achieves a function to control the printer mechanism 45 to print an image, text, or the like requested by the smartphone 2.

It is noted that the following description of this example assumes that the elements from the print module 85 to the BLE communication control module 87 are achieved as software functions. The elements from print module 85 to the BLE communication control module 87 may nonetheless be achieved in part or in whole by an integrated circuit (IC) or by hardware.

The communication control program of the printer device 3 may be recorded and provided in a computer-readable recording medium such as a CD-ROM and a flexible disk (FD) as an installable or executable file. The communication control program of the printer device 3 may even be recorded and provided in a computer-readable recording medium such as a CD-R, a DVD (Digital Versatile Disk), a Blu-ray disc (registered trademark), and a semiconductor memory. The communication control program of the printer device 3 may still be provided by being installed via a network such as the Internet. The communication control program of the printer device 3 may still be embedded and provided in a ROM of a device, for example.

### Outline of Basic Operations of Wireless LAN Communication System

In the wireless LAN communication system, the outer ellipse indicated by the solid line in FIG. 1 represents a wireless LAN communication-enabled range (the wireless LAN communication area 5) formed by the wireless LAN AP unit 16 of the communication range limiting device 1. The smartphone 2, the printer device 3, and the projector device 4 are disposed inside this wireless LAN communication area 5.

The smartphone 2 communicates with the printer device 3, the projector device 4, and other peripheral devices having the wireless LAN communication function to thereby be capable of remote control of, for example, printing of a desired image, text, or the like and projection of an image or the like via the wireless LAN.

The printer device 3, the projector device 4, and other peripheral devices include the wireless LAN communication units 47 and 67 and the BLE communication units 48 and 68. This arrangement enables BLE communication with the BLE communication unit 17 of the communication range limiting device 1. As indicated by the dotted-line ellipse in FIG. 1, however, the BLE communication area 6 is narrower than the wireless LAN communication area 5. Thus, whereas the BLE communication is enabled between each of the smartphone 2 and the printer device 3 that are disposed inside the BLE communication area 6, and the communication range limiting device 1, the BLE communication is disabled between the projector device 4 disposed outside the BLE communication area 6 and the communication range limiting device 1.

Specifically, the wireless LAN communication system performs the wireless LAN setup through the BLE communication as will be described later. As a result, only the smartphone 2 and the printer device 3 that are capable of the BLE communication can actually perform communication using the wireless LAN. The wireless LAN setup cannot be performed for the projector device 4 that is incapable of the BLE communication, even though the projector device 4 is disposed inside the wireless LAN communication area 5, so that the wireless LAN communication is disabled with the projector device 4.

Basic Connection Operation with Respect to Smartphone

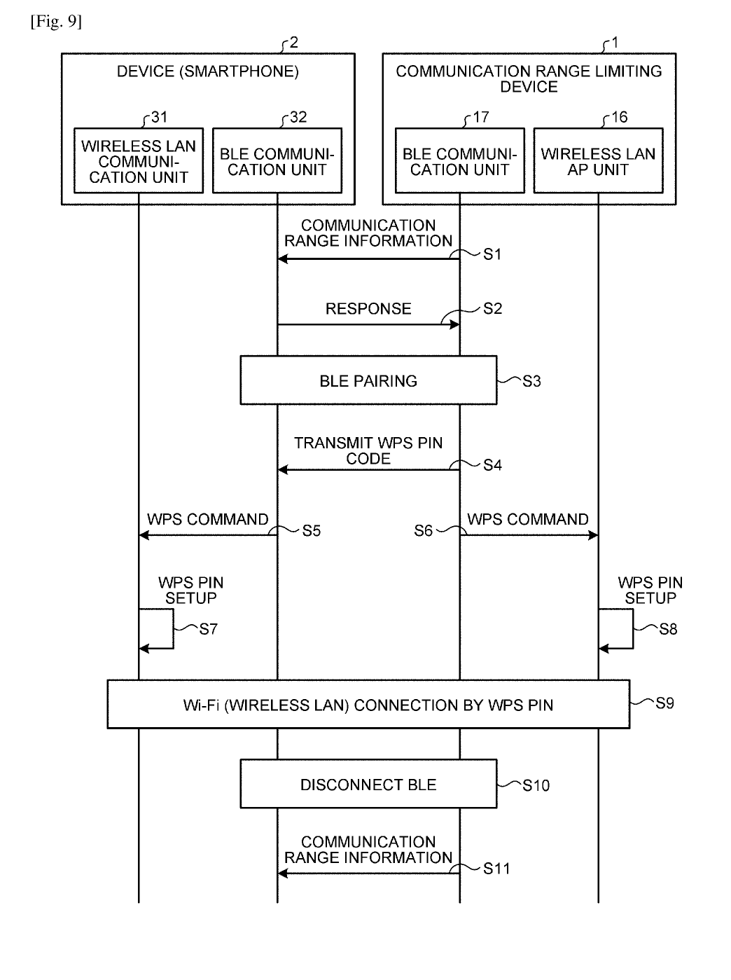

FIG. 9 is a sequence diagram illustrating that the smartphone 2 that has moved into the BLE communication area 6 within the wireless LAN communication area 5 establishes a wireless LAN communication line. The device connecting module 75 of the communication range limiting device 1 transmits, for example, an advertisement packet through three advertisement channels from the BLE communication control module 79 via the BLE communication unit 17 to thereby notify a peripheral device of presence of the communication range limiting device. The advertisement packet includes communication range information that indicates the BLE communication area 6. Step S1 denotes the transmission of the advertisement packet including the communication range information that indicates the BLE communication area 6.

When the smartphone 2 is located within the BLE communication area 6, the BLE communication unit 32 of the smartphone 2 receives the advertisement packet (the communication range information) that has been transmitted from the communication range limiting device 1. By referring to the received communication range information, the smartphone 2 determines whether the smartphone 2 is located within the BLE communication area 6. A result of this determination is transmitted to the communication range limiting device 1 through the BLE communication as a response denoted by Step S2. If the smartphone 2 is located within the BLE communication area 6, the BLE communication unit 32 of the smartphone 2 and the BLE communication unit 17 of the communication range limiting device 1 perform pairing for the BLE communication (BLE pairing) at Step S3. The BLE pairing enables the BLE communication between the smartphone 2 and the communication range limiting device 1.

When the BLE pairing is completed, the device connecting module 75 of the communication range limiting device 1 uses the BLE communication to transmit to the smartphone 2 at Step S4 a PIN code (unique identification information) of the WPS system that facilitates wireless LAN connection and is standardized by Wi-Fi Alliance. Additionally, the device connecting module 75 of the communication range limiting device 1 transfers to the wireless LAN AP unit 16, at Step S6, the PIN code that has been transmitted to the smartphone 2, thereby issuing a command to prepare for starting communication by the WPS system. The wireless LAN AP unit 16 of the communication range limiting device 1 performs setup for the WPS system using the PIN code transmitted to the smartphone 2 at Step S8.

The BLE communication unit 32 of the smartphone 2, having received the PIN code of the WPS system from the communication range limiting device 1, transfers at Step S5 the received PIN code to the wireless LAN communication unit 31, thereby issuing a command to prepare for starting communication by the WPS system. At Step S7, the wireless LAN communication unit 31 performs setup for the WPS system using the PIN code transferred from the communication range limiting device 1. At Step S9, this establishes Wi-Fi connection (wireless LAN connection) between the smartphone 2 and the communication range limiting device 1 by the WPS system through the use of the PIN code.

As described above, the wireless LAN communication system automatically completes the Wi-Fi connection (wireless LAN connection) when the smartphone 2 is located within the BLE communication area 6 of the communication range limiting device 1. This automatic connection establishment relieves the user of setup knowledge about the wireless LAN and a troublesome operation to input the PIN code. In addition, encrypted information is transmitted and received among different devices in BLE communication, so that the PIN code can be transmitted and received with security.

Next, at Step S10, the BLE communication control module 83 of the smartphone 2 and the BLE communication control module 79 of the communication range limiting device 1 temporarily disconnect the BLE communication in order to enable connection of a new device. Thereafter, at Step S11, the device connecting module 75 of the communication range limiting device 1 transmits an advertisement packet that includes the communication range information indicating the BLE communication area 6, as described previously with reference to Step S1. The device connecting module 75 of the communication range limiting device 1 then attempts to establish a wireless LAN communication line with a device such as the smartphone 2 located in the BLE communication area 6 through the BLE communication as described previously.

Basic Connection Operation with Respect to Printer Device

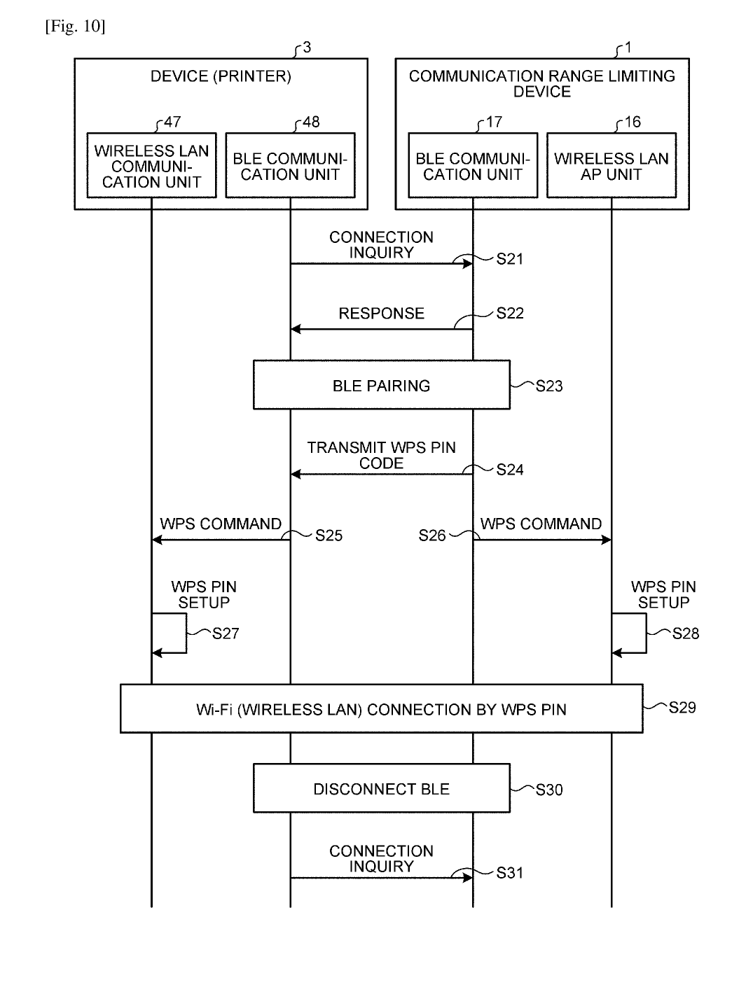

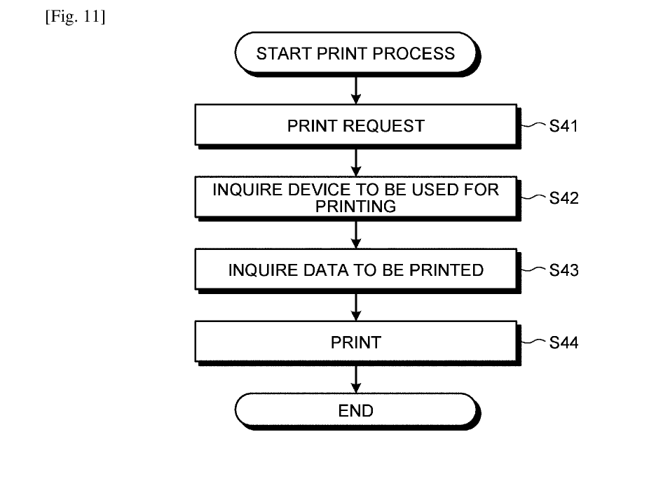

FIG. 10 is a sequence diagram illustrating that the printer device 3 disposed in the BLE communication area 6 within the wireless LAN communication area 5 establishes a wireless LAN communication line. The printer device 3 as a peripheral device effectively functions when it receives a print request from a device that makes a print request, such as the smartphone 2. Thus, to establish wireless LAN communication with the printer device 3, preferably, the smartphone 2 or the like that controls the printer device 3 has previously been connected to the wireless LAN. The sequence diagram illustrated in FIG. 10 assumes that the smartphone 2 has already been connected to the wireless LAN (see the description for FIG. 9). The sequence diagram illustrated in FIG. 10 starts its process with Step S21 when the transmission of an advertisement packet is enabled by the temporary disconnection of the BLE communication between the smartphone 2 and the communication range limiting device 1 at Step S10 illustrated in FIG. 9.

The printer device 3 is a stationary device disposed in the BLE communication area 6 of the communication range limiting device 1. At Step S21, the printer device 3 transmits, at regular intervals and through the abovementioned three advertisement channels, an advertisement packet that includes connection inquiry information for inquiring whether a device to make a print request such as the smartphone 2 has been connected to the wireless LAN to the communication range limiting device 1 via the BLE communication unit 48. The peripheral device connecting module 76 of the communication range limiting device 1 illustrated in FIG. 6 transmits, at Step S22 to the printer device 3 via the BLE communication unit 17, a response that indicates whether a device to make a print request has been connected.

If a device to make a print request such as the smartphone 2 has been connected to the wireless LAN, the peripheral device connecting module 76 of the communication range limiting device 1 and the BLE communication unit 48 of the printer device 3 perform pairing for the BLE communication (BLE pairing) at Step S23. The BLE pairing enables the BLE communication between the printer device 3 and the communication range limiting device 1.

When the BLE pairing is completed, the peripheral device connecting module 76 of the communication range limiting device 1 transmits to the printer device 3 at Step S24 a PIN code of the WPS system that facilitates wireless LAN connection and is standardized by Wi-Fi Alliance. Additionally, the communication range limiting device 1 transfers, at Step S26 to the wireless LAN AP unit 16, the PIN code that has been transmitted to the printer device 3, thereby issuing a command to prepare for starting communication by the WPS system. The wireless LAN AP unit 16 of the communication range limiting device 1 performs setup for the WPS system using the PIN code transmitted to the printer device 3 at Step S28.

The BLE communication unit 48 of the printer device 3, having received the PIN code of the WPS system from the communication range limiting device 1, transfers at Step S25 the received PIN code to the wireless LAN communication unit 47, thereby issuing a command to prepare for starting communication by the WPS system. At Step S27, the wireless LAN communication unit 47 performs setup for the WPS system using the PIN code transferred from the BLE communication unit 48. At Step S29, this establishes Wi-Fi connection (wireless LAN connection) between the printer device 3 and the communication range limiting device 1 by the WPS system through the use of the PIN code.

Next, at Step S30, the BLE communication unit 48 of the printer device 3 and the BLE communication unit 17 of the communication range limiting device 1 temporarily disconnect the BLE communication in order to enable connection of a new device. Thereafter, at Step S31, the BLE communication unit 48 of the printer device 3 transmits an advertisement packet that includes the connection inquiry information, as described previously with reference to Step S21. When a device to make a print request is connected to the wireless LAN, the communication range limiting device 1 establishes a wireless LAN communication line with the printer device 3 located in the BLE communication area 6 through the BLE communication as described previously.

### Print Operation

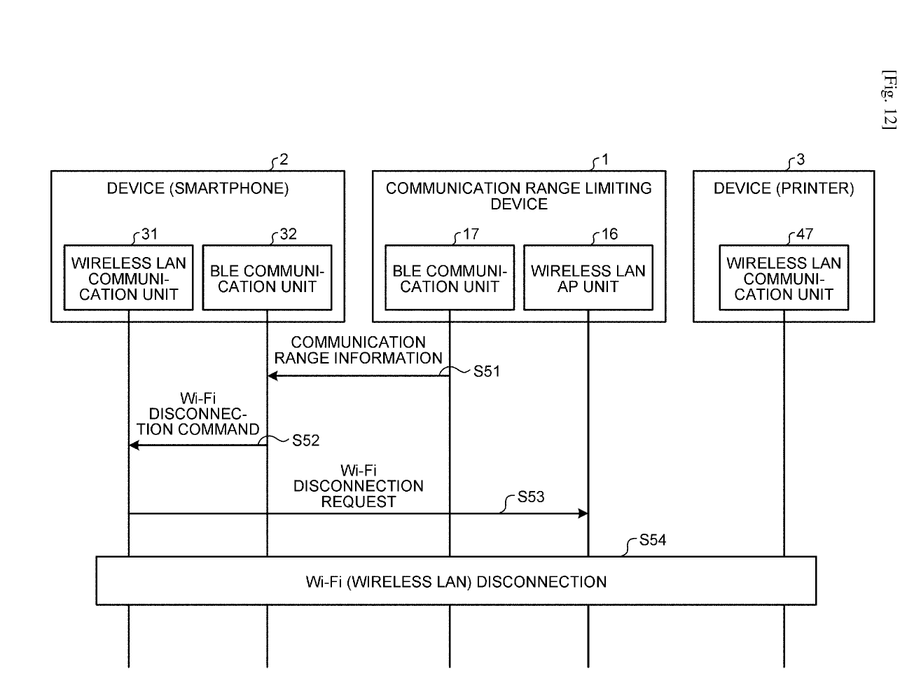

The flowchart illustrated in FIG. 11 illustrates that the smartphone 2 connected to the wireless LAN remotely controls and causes the printer device 3 to produce a printed matter. As described previously, the mutual connection established between the smartphone 2 and the printer device 3 via the wireless LAN communication units 31 and 47 in the wireless LAN enables remote control of the printer device 3 by the smartphone 2.

When using the smartphone 2 to remotely control the printer device 3, the user operates to start a print application program stored in memory of, for example, the ROM 22 of the smartphone 2. When the print application program is started to operate, the print request module 81 of the smartphone 2 illustrated in FIG. 7 makes a print request to the printer device 3 via the wireless LAN communication control module 82 and the wireless LAN communication unit 31 at Step S41. The print module 85 of the printer device 3 illustrated in FIG. 8, upon receipt of the print request, inquires a device to be used for printing of the smartphone 2 via the wireless LAN communication unit 47 at Step S42. If data stored in the smartphone 2 is to be printed, the user notifies the printer device 3 that the device to be used for printing is the smartphone 2 through the wireless LAN communication. If an image projected with the projector device 4, for example, is to be printed, the user notifies the printer device 3 that the device to be used for printing is the projector device 4 through the wireless LAN communication.

At Step S43, the print module 85 of the printer device 3 inquires data to be printed of the smartphone 2 through the wireless LAN communication. If data, such as an image or text, stored in the smartphone 2 is to be printed, the user notifies the printer device 3 that the data to be printed is data stored in the smartphone 2 through the wireless LAN communication. Alternatively, if an image or other data projected with the projector device 4 is to be printed, the user notifies the printer device 3 that the data to be printed is data projected with the projector device 4 through the wireless LAN communication. Finally, at Step S44, the print module 85 of the printer device 3 executes printing by acquiring the data specified by the user from the device specified by the user (the smartphone 2 or the projector device 3) through the wireless LAN communication.

### Device Disconnecting Operation

FIG. 12 is a sequence diagram illustrating that the wireless LAN communication line (and the BLE communication line) is disconnected when the smartphone 2 connected in the BLE communication area 6 to the printer device 3 through the wireless LAN moves out of the BLE communication area 6. At Step S51, as described previously, the communication range information that indicates the communication range corresponding to the BLE communication area 6 is transmitted from the BLE communication unit 17 of the communication range limiting device 1 to the smartphone 2 through the BLE communication. The smartphone 2 compares the position of the communication range limiting device detected by, for example, its global positioning system (GPS) with the BLE communication area 6 indicated by the communication range information. The smartphone 2, when having detected that the communication range limiting device is outside the BLE communication area 6, instructs the wireless LAN communication unit 31 to disconnect the wireless LAN (Wi-Fi disconnection command) at Step S52.

It is noted that, in this example, the communication range limiting device 1 transmits the communication range information to the smartphone 2 and the smartphone 2 compares the current position of the communication range limiting device with the BLE communication area 6 indicated by the communication range information to thereby detect withdrawal from the BLE communication area 6. Another arrangement may nonetheless be made in which the smartphone 2 transmits the current position of the communication range limiting device detected with the GPS or the like to the communication range limiting device 1 through the BLE communication and the communication range limiting device 1 compares the current position of the smartphone 2 with the BLE communication area 6 to thereby detect withdrawal of the device such as the smartphone 2 from the BLE communication area 6. In this arrangement, the withdrawal detecting module 77 illustrated in FIG. 6 is to detect the withdrawal of the device such as the smartphone 2 from the BLE communication area 6.

The wireless LAN communication unit 31 of the smartphone 2, when instructed by the BLE communication unit 32 to disconnect the wireless LAN, requests the communication range limiting device 1 to disconnect the wireless LAN using the wireless LAN communication at Step S53. The communication range limiting device 1, upon receipt of the wireless LAN disconnection request, disconnects the wireless LAN communication line associated with the device that has made the wireless LAN disconnection request as indicated by Step S54. This disconnects the wireless LAN communication line for not only the smartphone 2, but also the printer device 3.

To re-establish the wireless LAN communication line after it has been disconnected, the communication range limiting device 1 renews the PIN code. As a result, when the smartphone 2 that has moved out of the BLE communication area 6 re-enters the BLE communication area 6, the wireless LAN communication line is established using a PIN code different from the previous one.

As described above, the wireless LAN communication system can automatically disconnect the wireless LAN communication line and the BLE communication line when the smartphone 2 moves out of the BLE communication area 6. This capability allows the range in which the smartphone 2 can be connected to the wireless LAN to be limited to a predetermined range (within the BLE communication area 6). In addition to the smartphone 2 that has moved out of the BLE communication area 6, the wireless LAN communication system further disconnects the wireless LAN communication line of the printer device 3 that has been communicating with the smartphone 2. This arrangement prevents an inconvenience in which the connection of the printer device 3 to the wireless LAN communication line that is no longer used as a result of the disconnection of the wireless LAN communication line with respect to the smartphone 2 continues to exist wastefully, so that an even greater communication security can be achieved. Specifically, even a user who is not authorized to connect to a local network such as an in-house LAN is temporarily and simply allowed to have his or her device connected to the local network and to use his or her device, while security of the local network is ensured.

Additionally, the PIN code is renewed when the wireless LAN communication line that has previously been disconnected is to be re-established. This arrangement prevents the following illegal act: the smartphone 2 that has moved out of the BLE communication area 6 reuses the PIN code used in the last connection to thereby attempt to intercept another device through the wireless LAN communication.

When the smartphone 2 moves out of the BLE communication area 6, the wireless LAN communication line is disconnected of the printer device 3 that has been communicating with the smartphone 2 as well as the smartphone 2. This arrangement prevents an inconvenience in which the connection of the printer device 3 to the wireless LAN communication line that is no longer used as a result of the disconnection of the wireless LAN communication line with respect to the smartphone 2 continues to exist wastefully, so that an even greater communication security can be achieved.

It is noted that a public key may be delivered in place of the PIN code of the WPS system that is delivered from the communication range limiting device 1 to a device such as the smartphone 2 through the BLE communication when the wireless LAN communication line is to be established. The wireless LAN communication line may be established by delivering, in place of the PIN code of the WPS system, a public key according to the Diffie-Hellman key exchange method, for example. In this case, the public key is transmitted and received within the BLE communication area 6, so that a wireless LAN administrator can monitor the transmission and reception of the public key. This approach clarifies, for example, the specific device that transmits the public key, the specific device that receives the public key, and the specific user. Thus, illegal communications by an illegal user and an illegal device, what is called spoofing, can be prevented. In addition, when the wireless LAN communication line that has previously been disconnected is to be re-established, preferably, a new public key different from the previous one is used as with the PIN code described previously.

Additionally, the PIN code or the public key may be transmitted by sound (an acoustic output propagating through a space) from the communication range limiting device 1 to a device such as the smartphone 2 or the printer device 3. Because the acoustic output offers spatial transmissibility poorer than that of the radio waves used in the BLE communication, the transmission and reception range of the PIN code, for example, can be limited to a range over which sound can be transmitted and received between devices. Thus, the PIN code or the like is transmitted and received in a narrow range which a system administrator, for example, can monitor. As a result, illegal communications by an illegal user and an illegal device, what is called spoofing, mentioned previously can be prevented even more reliably.

Additionally, presence of a device within the BLE communication area 6 may be monitored using received signal strength indication (RSSI) of the BLE communication unit 17 instead of the communication range information. By setting the received signal strength indications of the BLE communication regarded as an exit RSSI area and an entrance RSSI area to desired levels, the range over which connection can be made to the wireless LAN (range of the entrance RSSI area) can be dynamically adjusted within the BLE communication area 6.

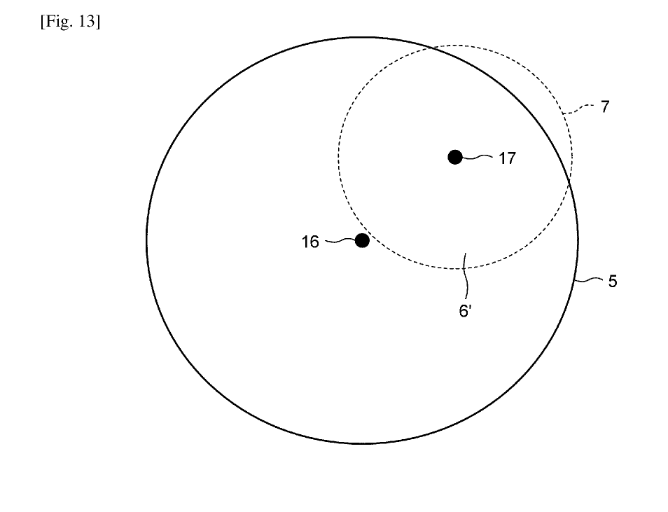

The above-described example encompasses the BLE communication area within the wireless LAN communication area. Nonetheless, as illustrated, for example, in FIG. 13, at least part of the BLE communication area may be disposed outside the wireless LAN communication area. In FIG. 13, a BLE communication area 6′ represents an area in which the wireless LAN communication line can be established. This is because in a BLE communication area 7 outside the wireless LAN communication area, the setup for performing the wireless LAN communication cannot be made, though communication range information can be received through BLE communication. The condition illustrated in FIG. 13 is possible, for example, in a case in which the wireless LAN AP unit 16 and the BLE communication unit 17 are disposed at different positions and in a case in which the communication-enabled range protrudes in one direction because of communication directivity concerned.

### Improvement

In the wireless LAN communication system having the basic configuration described above, the distance over which each of the devices can communicate using the wireless LAN communication is limited to short distances within the BLE communication area 6. When the above-described wireless LAN communication system exists in plurality at places that are physically apart from each other, enhanced convenience can be achieved, if devices in the different wireless LAN communication systems can communicate with each other. Specifically, when no printer devices exist in a first wireless LAN communication system, a smart device disposed in the first wireless LAN communication system can operate a printer device disposed in a second wireless LAN communication system to perform printing on the printer device disposed in the second wireless LAN communication system.

The wireless LAN communication system described above, however, achieves enhanced security by setting the BLE communication area 6 within the wireless LAN communication area 5 to thereby permit and control use of the wireless LAN in a limited range within the wireless LAN communication area 5. Thus, a need exists to maintain such enhanced security even when communication is enabled between the devices disposed in different wireless LAN communication systems that exist at places physically apart from each other.

In one embodiment, in an environment including a plurality of wireless LAN communication systems that exist at places physically apart from each other, an Internet Protocol Version 6 (IPv6) address having a specific prefix is distributed to each of the wireless LAN communication systems and a virtual private network (VPN) connection is established among the wireless LAN communication systems. In addition, the wireless LAN communication systems exchange information on lists of devices held by respective wireless LAN communication systems during the VPN connection. Each of the wireless LAN communication systems performs communication control of the devices using the list information. This arrangement enables communication between devices disposed in different wireless LAN communication systems that exist at places that are physically apart from each other with enhance security.

### System Configuration of Wireless LAN Communication System in Embodiment

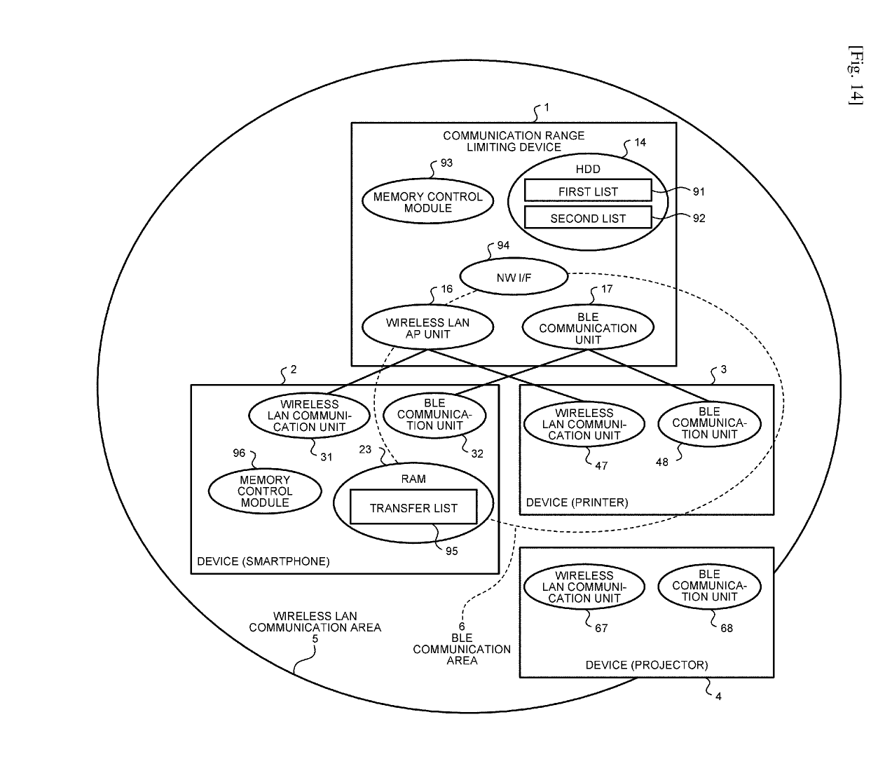

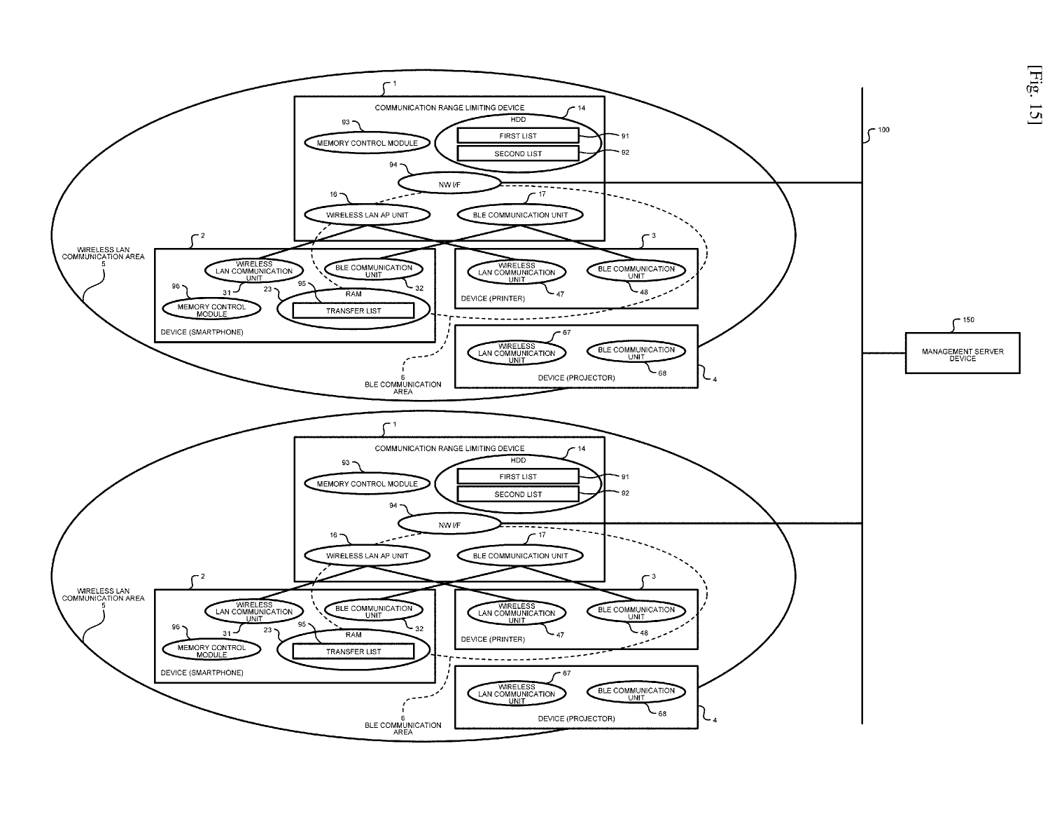

FIG. 14 is a system configuration diagram of the wireless LAN communication system in the embodiment in which the above-described improvement has been made. As will be described with reference to FIG. 15, the wireless LAN communication system in the embodiment can perform mutual communication with other wireless LAN communication systems through the VPN connection established between the wireless LAN communication systems. FIG. 14 illustrates a single wireless LAN communication system. In FIG. 14, like operations are identified by like reference numerals as in the wireless LAN communication system having the above-described basic configuration described with reference to FIG. 1.

As illustrated in FIG. 14, in the wireless LAN communication system in the embodiment, the communication range limiting device 1 includes the HDD 14 that holds a first list 91 that lists smart devices such as the smartphones 2 located within the BLE communication area 6 within the wireless LAN communication area 5. The wireless LAN communication area 5 is an exemplary first communication range in which first wireless communication is performed using a first communication sch such as Wi-Fi wireless communication. The BLE communication area 6 is an exemplary second communication range in which second wireless communication is performed using a second communication scheme such as BLE communication.

In addition, the HDD 14 of the communication range limiting device 1 holds a second list 92 that lists peripheral devices such as the printer devices 3 and the projector device 4 located within the BLE communication area 6. The communication range limiting device 1 further includes a memory control module 93 that performs memory control of the first list 91 and the second list 92 with respect to the HDD 14. The communication range limiting device 1 further includes a network interface (NW I/F) 94 for establishing a VPN connection with another wireless LAN communication system. The memory control module 93 is an exemplary generating module. The smart devices and the peripheral devices are each an exemplary communication device.

Additionally, in the wireless LAN communication system in the embodiment, the smartphone 2 has a transfer list 95 stored in the RAM 23 and includes a memory control module 96 that performs memory control of the transfer list 95 with respect to the RAM 23. The transfer list 95 to be described later is transmitted from the communication range limiting device 1 to a smart device such as the smartphone 2 located within the BLE communication area 6. The transfer list 95 contains, for example, the type, the IPv6 address, and control information of each device within the BLE communication area 6 and the IPv6 address of the wireless LAN communication system to which the device belongs.

### VPN Connection of Wireless LAN Communication System

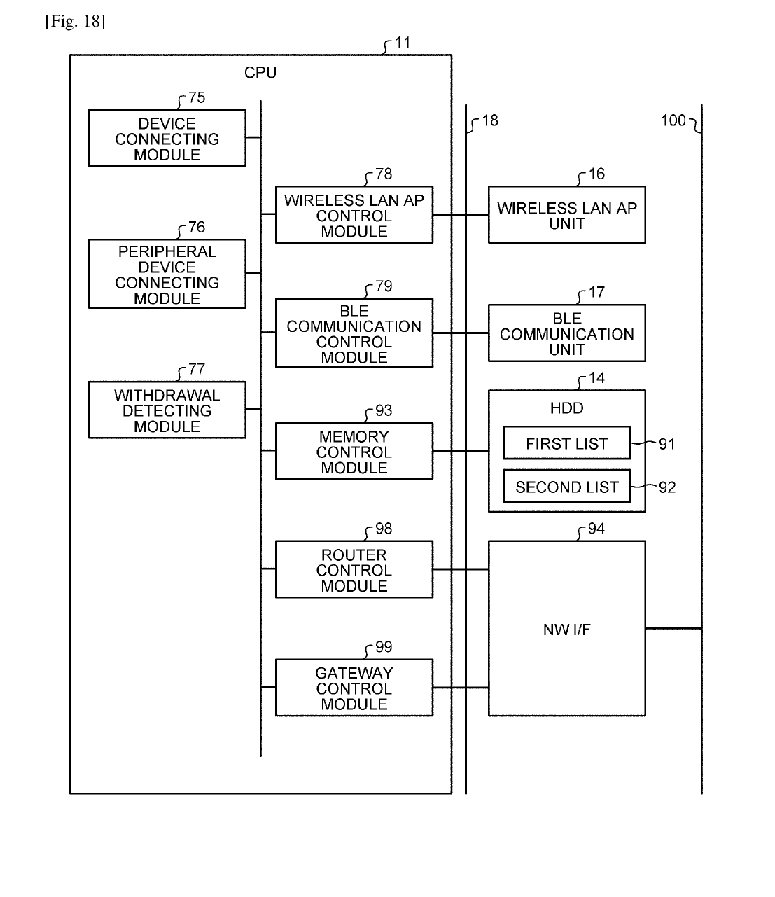

FIG. 15 is a diagram illustrating an exemplary VPN connection established between two wireless LAN communication systems. As illustrated in FIG. 15, the VPN connection is established between the two wireless LAN communication systems when the NW I/F 94 in each of the wireless LAN communication systems connects to an Internet 100. The VPN connection is an exclusive external network connection in which a network address assigned to a particular wireless LAN communication system is not duplicated. A management server device 150 on the Internet 100 has a name resolution function and an authentication function with respect to a gateway control module (denoted by reference numeral 99 in FIG. 18) of each NW I/F 94. The management server device 150 performs and controls the VPN connection for each wireless LAN communication system.

### Hardware Configuration of Wireless LAN Communication System in Embodiment

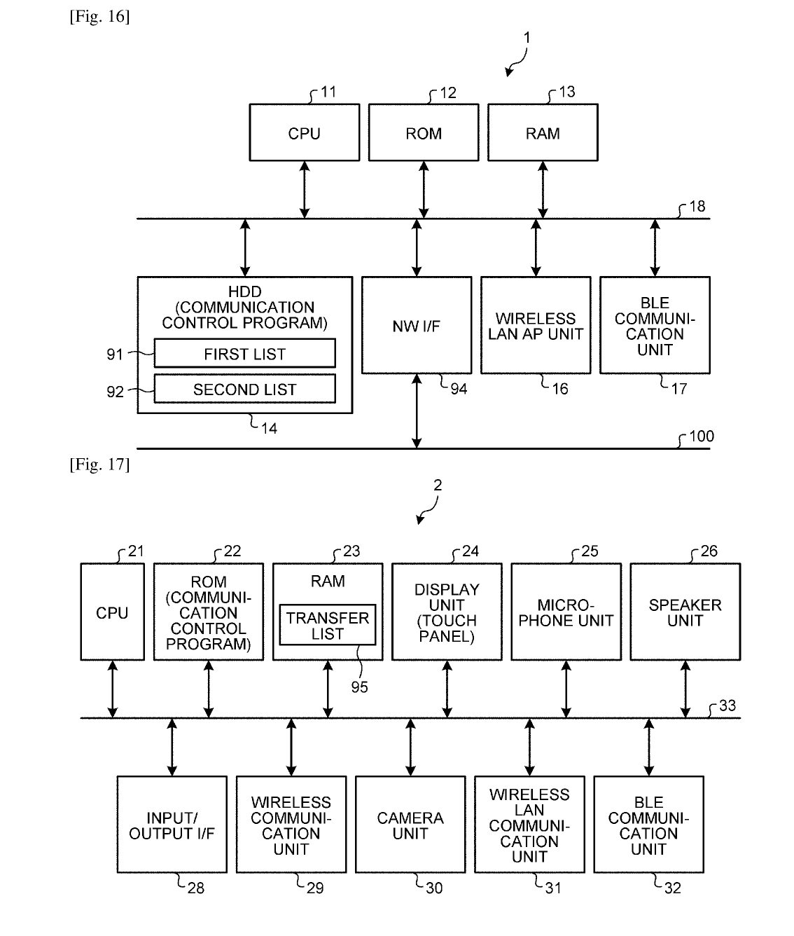

FIG. 16 illustrates a hardware configuration of the communication range limiting device 1 included in the wireless LAN communication system in the embodiment. As in the basic configuration, the communication range limiting device 1 includes the elements from the CPU 11 to the BLE communication unit 17 connected to each other via the bus line 18. The CPU 11 functions as a memory control module (denoted by reference numeral 93 in FIG. 18) in accordance with the communication control program to thereby perform memory control of the first list 91 and the second list 92 with respect to the HDD 14.

In addition, the communication range limiting device 1 can also connect to a wide area network such as the Internet 100 via the NW I/F 94. The CPU 11 functions, as will be later described, as a router control module (denoted by reference numeral 98 in FIG. 18) and the gateway control module (denoted by reference numeral 99 in FIG. 18) in accordance with the communication control program stored in the ROM 12 or the HDD 14, for example, to thereby control the VPN connection between the wireless LAN communication systems via the NW I/F 94.

FIG. 17 illustrates a hardware configuration of the smartphone 2 included in the wireless LAN communication system in the embodiment. As in the basic configuration, the smartphone 2 includes the elements from the CPU 21 to the speaker unit 26 and from the input/output I/F 28 to the BLE communication unit 32 connected to each other via the bus line 33. The CPU 21 functions as the memory control module 96 in accordance with the communication control program stored in the ROM 22 to thereby perform memory control of the transfer list 95 transferred from the communication range limiting device 1 with respect to the RAM 23. As described previously, the transfer list 95 contains, for example, the type, IP address, and control information of each device within the BLE communication area 6. A specific device having required control information can thus be selected and controlled by referring to the transfer list 95, so that convenience of the wireless LAN communication system can be improved.

### Software Configuration of Wireless LAN Communication System in Embodiment

FIG. 18 is a block diagram illustrating functions achieved by the CPU 11 of the communication range limiting device 1 when the CPU 11 executes the communication control program. As illustrated in FIG. 18, the CPU 11 executes the communication control program to thereby achieve a function of each of the above-described elements from the device connecting module 75 to the BLE communication control module 79, and the memory control module 93. Additionally, the CPU 11 executes the communication control program to thereby achieve a function of each of the router control module 98 and the gateway control module 99.

As will be described later, the memory control module 93 generates the first list 91 that lists smart devices such as smartphones 2 located within the BLE communication area 6 and stores the first list 91 in memory of, for example, the HDD 14. The memory control module 93 further generates the second list 92 that lists peripheral devices such as the printer devices 3 and the projector devices 4 located within the BLE communication area 6 and stores the second list 92 in memory of, for example, the HDD 14. The router control module 98 performs routing and addressing when, as illustrated in FIG. 15, communication is performed with another wireless LAN communication system that exists at a physically remote place via a wide area network such as the Internet 100. The gateway control module 99 performs, for example, protocol conversion to thereby enable communication with another wireless LAN communication system that exists at a physically remote place. The gateway control module 99 is exemplary connecting module, acquiring module, and remote communication control module.

It is noted that the following description of this example assumes that the elements from the device connecting module 75 to the BLE communication control module 79, the memory control module 93, the router control module 98, and the gateway control module 99 are achieved as software functions by the communication control program. The elements from the device connecting module 75 to the BLE communication control module 79, the memory control module 93, the router control module 98, and the gateway control module 99 may nonetheless be achieved in part or in whole by an integrated circuit (IC) or by hardware. Understandably, the communication control program of the communication range limiting device 1 may be recorded and provided in a computer-readable recording medium such as a CD-ROM and a semiconductor memory as an installable or executable file as described previously. Additionally, the wireless LAN AP unit 16 of the communication range limiting device 1 is an exemplary first communication unit. The BLE communication unit 17 of the communication range limiting device 1 is an exemplary second communication unit.

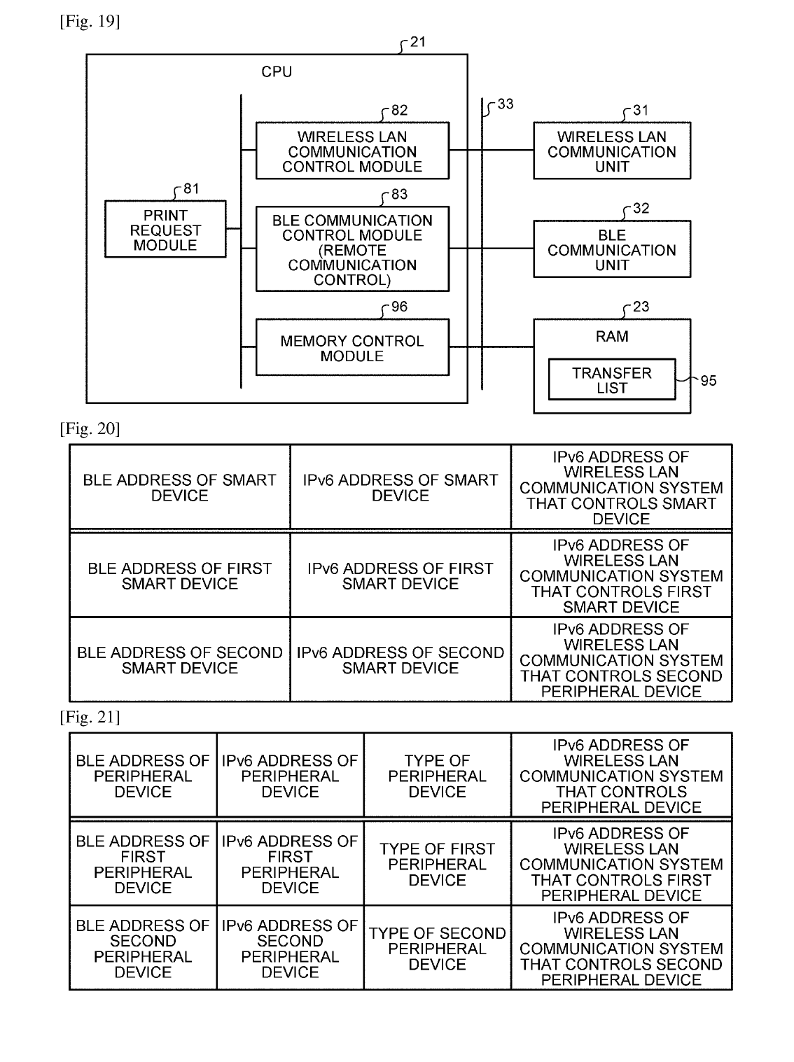

FIG. 19 is a block diagram illustrating functions achieved by the CPU 21 of the smartphone 2 when the CPU 21 executes the communication control program. As illustrated in FIG. 19, the CPU 21 executes the communication control program to thereby achieve a function of each of the above-described elements from the print request module 81 to the BLE communication control module 83, and the memory control module 96. The memory control module 96 stores the transfer list 95 transferred from the communication range limiting device 1 in memory of, for example, the RAM 23. As will be described later, the transfer list 95 lists the type and IP address of each device within the BLE communication area 6 and control information such as a print setup.

The BLE communication control module 83 has a connection request function that, in response to a user operation, makes a communication connection request to another wireless LAN communication system that exists at a physically remote place. The BLE communication control module 83 further has a disconnection function that, in response to a communication disconnection request transmitted from another wireless LAN communication system that exists at a physically remote place, disconnects the communication with the other wireless LAN communication system. In FIG. 19, the connection request function and the disconnection function of the BLE communication control module 83 are depicted as a “remote communication control” function.

### Specific Example of First List

FIG. 20 illustrates an exemplary first list 91. The first list 91 is exemplary first information and second information. A smart device such as the smartphone 2 located within the BLE communication area 6 is recognized by the communication range limiting device 1 through the BLE communication as described previously. The memory control module 93 of the communication range limiting device 1 generates the first list 91 that includes a BLE address and an IPv6 address of the recognized smart device and an IPv6 address of the wireless LAN communication system to which the smart device belongs, and then registers the generated first list 91 in the HDD 14. The communication range limiting device 1 can identify and recognize a smart device that moves in and out of the BLE communication area using the first list 91.

The IPv6 address of the wireless LAN communication system to which a specific smart device belongs represents an IPv6 address of the wireless LAN communication system that controls the smart device in question. The IPv6 address of the smart device is a Wi-Fi address that is an exemplary first address. A Bluetooth address is an exemplary second address. The IPv6 address of the wireless LAN communication system to which the smart device belongs is an exemplary network address that is assigned to a particular wireless LAN communication system and that is not duplicated.

Briefly, when a communication line is established with another wireless LAN communication system that exists at a physically remote place, the other wireless LAN communication system at the remote side transmits the IPv6 address of the wireless LAN communication system at the remote side and the IPv6 address of the smart device controlled by the wireless LAN communication system at the remote side. The memory control module 93 of the communication range limiting device 1 generates the above-described first list 91 that includes also the IPv6 address of the wireless LAN communication system at the remote side and the IPv6 address of the smart device controlled by the wireless LAN communication system at the remote side. This results in the first list 91 storing not only the information on the wireless LAN communication system at the host side, but also the information on the wireless LAN communication system at the remote side when the communication line is established with another wireless LAN communication system that exists at a physically remote place.

### Specific Example of Second List

FIG. 21 illustrates an exemplary second list 92. The second list 92 is exemplary first information and second information. A peripheral device such as the printer device 3 and the projector device 4 located within the BLE communication area 6 is recognized, as with the smartphone 2, by the communication range limiting device 1 through the BLE communication. The memory control module 93 of the communication range limiting device 1 generates the second list 92 that includes a BLE address and an IPv6 address of the recognized peripheral device, for example, type information of the peripheral device such as the printer device 3 or the projector device 4, and an IPv6 address of the wireless LAN communication system to which the peripheral device belongs. The memory control module 93 registers the generated second list 92 in the HDD 14. In addition, the memory control module 93 registers also control information of each peripheral device in the second list 92. The control information includes, for example, an authentication password as well as setup information, such as monochrome printing or color printing, if the peripheral device is a printer device. The communication range limiting device 1 can identify and recognize a peripheral device that moves in and out of the BLE communication area 6 using the second list 92.

Briefly, when a communication line is established with another wireless LAN communication system that exists at a physically remote place, the other wireless LAN communication system at the remote side transmits the IPv6 address of the wireless LAN communication system at the remote side, the IPv6 address of the peripheral device controlled by the wireless LAN communication system at the remote side, and the abovementioned control information. The memory control module 93 of the communication range limiting device 1 generates the above-described second list 92 that includes also the IPv6 address of the wireless LAN communication system at the remote side, the IPv6 address of the peripheral device controlled by the wireless LAN communication system at the remote side, and the control information. This results in the second list 92 storing not only the information on the wireless LAN communication system at the host side, but also the information on the wireless LAN communication system at the remote side when the communication line is established with another wireless LAN communication system that exists at a physically remote place.

### Specific Example of Transfer List

The communication range limiting device 1 transfers to each smart device, such as the smartphone 2, the transfer list 95 that includes, out of information on the peripheral device registered in the second list 92 illustrated in FIG. 21, the type of the peripheral device, the IPv6 address of the peripheral device, control information of the peripheral device, and the IPv6 address of the wireless LAN communication system to which the peripheral device belongs. It is noted that the BLE address for determining movement to and from the BLE communication area 6 is not to be included in the transfer list 95 (not to be transferred). When a communication line is established with another wireless LAN communication system that exists at a physically remote place, the information on the type of the peripheral device, the IPv6 address of the peripheral device, control information of the peripheral device, and the IPv6 address of the wireless LAN communication system to which the peripheral device belongs to the other wireless LAN communication system at the remote side are included in the transfer list 95 and transferred.

Each smart device registers in RAM 23 the transfer list 95 of each peripheral device transferred from the communication range limiting device 1 (see FIGS. 14, 15, and 17). The user may refer to the transfer list 95 when, for example, to perform printing. This enables the user to select a specific printer device 3 having a desired print setup. Alternatively, the user may refer to the transfer list 95 in order to acquire a password of the selected printer device 3 before performing printing. The use of the acquired password, for example, enables smooth printing. When a communication line is established with another wireless LAN communication system that exists at a physically remote place, the information on the types of the peripheral devices, control information, and the like on the other wireless LAN communication system at the remote side can be recognized. This enables printing of desired data using a printer device available at the other wireless LAN communication system.

### IPv6 Address Setting Operation for Wireless LAN Communication System

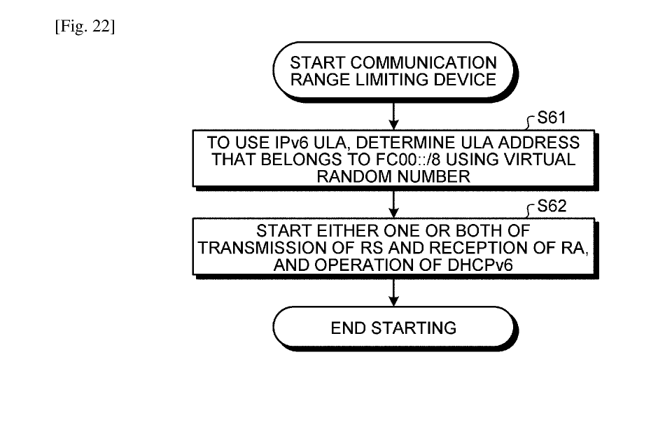

A flowchart illustrated in FIG. 22 illustrates operations performed to set an IPv6 address upon starting of the wireless LAN communication system. The communication range limiting device 1 of the wireless LAN communication system uses exemplarily unique local IPv6 unicast addresses (ULAs) defined in RFC 4193 to thereby automatically set the IPv6 address for the communication range limiting device 1. RFC is an abbreviation for “Request for Comments”.

More specifically, the communication range limiting device 1 sets, at Step S61, a virtual random number generated according to the step specified in RFC 4193 for a prefix that belongs to FC00::/8 to thereby generate a link-local address. Then, at Step S62, the communication range limiting device 1 transmits a router solicitation (RS) command via the NW I/F 94 using the generated link-local address as a transmitter address of an IPv6 packet, thereby requesting a router advertisement (RA).

The communication range limiting device 1 next receives a RA returned in response to the RS command to thereby acquire prefix information in a network interface. The communication range limiting device 1 then generates, for example, a 128-bit IPv6 address from the acquired prefix information and interface identification (ID) based on a media access control (MAC) address of the host node. The communication range limiting device 1 performs address collision detection for the generated IPv6 address. The communication range limiting device 1, when having detected no address collision, validates the generated IPv6 address. The foregoing steps set the IPv6 address for the wireless LAN communication system. The communication range limiting device 1 causes the memory control module 93 to register the IPv6 address that has been set as described above for the wireless LAN communication system in the first list 91 and the second list 92.

The communication range limiting device 1 responds to IPv6 address user settings by Dynamic Host Configuration Protocol version 6 (DHCPv6) at Step S62.

### Smart Device Connecting Operation

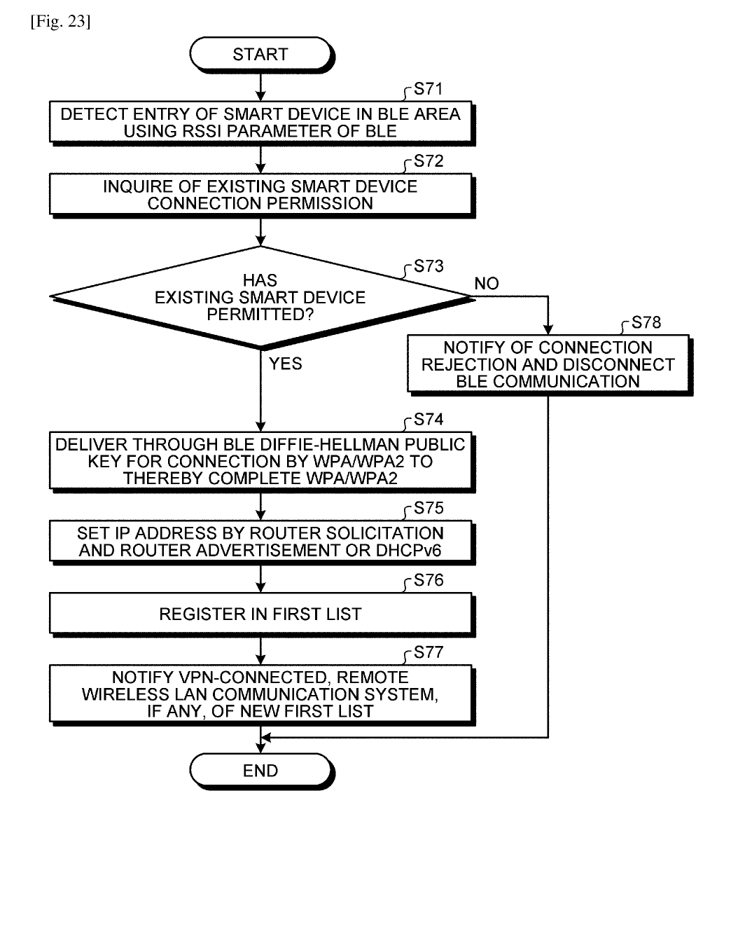

A flowchart illustrated in FIG. 23 illustrates steps to be performed for establishing a wireless LAN communication line connection in the smart device such as the smartphone 2 that has moved into the BLE communication area 6. The communication range limiting device 1 uses, for example, received signal strength indication (RSSI parameter) of the BLE communication unit 17 to detect a smart device that moves in or out of the BLE communication area 6. At Step S71 of the flowchart illustrated in FIG. 23, the device connecting module 75 of the communication range limiting device 1 detects movement of a smart device to or from the BLE communication area 6 on the basis of the RSSI parameter of the BLE communication unit 17.

The device connecting module 75 illustrated in FIG. 18, when having detected movement of a smart device to or from the BLE communication area 6, inquires, at Step S72, of the first list 91 of the HDD 14 via the memory control module 93 presence of a previously connected smart device. If a previously connected smart device exists, the device connecting module 75 inquires, at Step S73, of the smart device registered in the first list 91 via the BLE communication control module 79 and the BLE communication unit 17 whether a new smart device can be connected.

If a response rejecting connection of a new smart device is received from the previously connected smart device as a result of the inquiry about whether a new smart device can be connected (No at Step S73), the device connecting module 75 notifies the smart device that has been detected to be moved into the BLE communication area 6 of connection rejection via the BLE communication control module 79 and the BLE communication unit 17 at Step S78. The device connecting module 75 then disconnects the BLE communication and terminates the steps of the flowchart illustrated in FIG. 23.

It is noted that the step of inquiring of the previously connected smart device the connection of a new smart device to thereby obtain permission at Step S72, Step S73, and Step S78 may be omitted.

If a response permitting connection of a new smart device is received from the previously connected smart device as a result of the inquiry about whether a new smart device can be connected (Yes at Step S73), and if no previously connected smart devices exist (no smart devices are registered in the first list 91), the device connecting module 75 delivers, at Step S74, a public key according to, for example, the Diffie-Hellman key exchange method to the new smart device via the BLE communication control module 79 and the BLE communication unit 17 through BLE communication.

This step causes an IP address (Wi-Fi address) of the new smart device to be automatically set through Wi-Fi wireless communication line setup by WPA/WPA2 in the new smart device and the communication range limiting device 1, so that the new smart device is connected to the wireless LAN (Wi-Fi connection). The new smart device causes the wireless LAN communication control module 82 to perform wireless LAN setup control using the public key received by the BLE communication unit 32.

When the wireless LAN communication line is established with the new smart device, the device connecting module 75 of the communication range limiting device 1 transmits a RS command and receives a RA returned in response to the RS command via the NW I/F 94 to thereby acquire prefix information in the network interface. The device connecting module 75 next generates, for example, a 128-bit IPv6 address from the acquired prefix information and the interface ID based on the MAC address of the new smart device. The communication range limiting device 1 performs address collision detection for the generated IPv6 address. The communication range limiting device 1, when having detected no address collision, sets the generated IPv6 address as the IPv6 address of the new smart device. It is noted that, at Step S75, the IPv6 address may be set by DHCPv6 in response to user operation.

At Step S76, the memory control module 93 of the communication range limiting device 1 registers the IPv6 address of the new smart device set as described above in the first list 91. When another wireless LAN communication system connected by, for example, VPN connection exists at a physically remote place, the device connecting module 75 notifies the other wireless LAN communication system of the first list 91. The memory control module 93 of the communication range limiting device 1 of the other wireless LAN communication system stores in the HDD 14 the reported first list 91 as the first list 91 of the smart device controlled by the other wireless LAN communication system (second information). This is the end of the steps of the flowchart illustrated in FIG. 23.

A PIN code in place of the public key may be delivered at Step S74. The public key, the PIN code, and the like are exemplary setup information for establishing a communication line of first wireless communication. The PIN code is exemplary unique identification information.

### Peripheral Device Connecting Operation

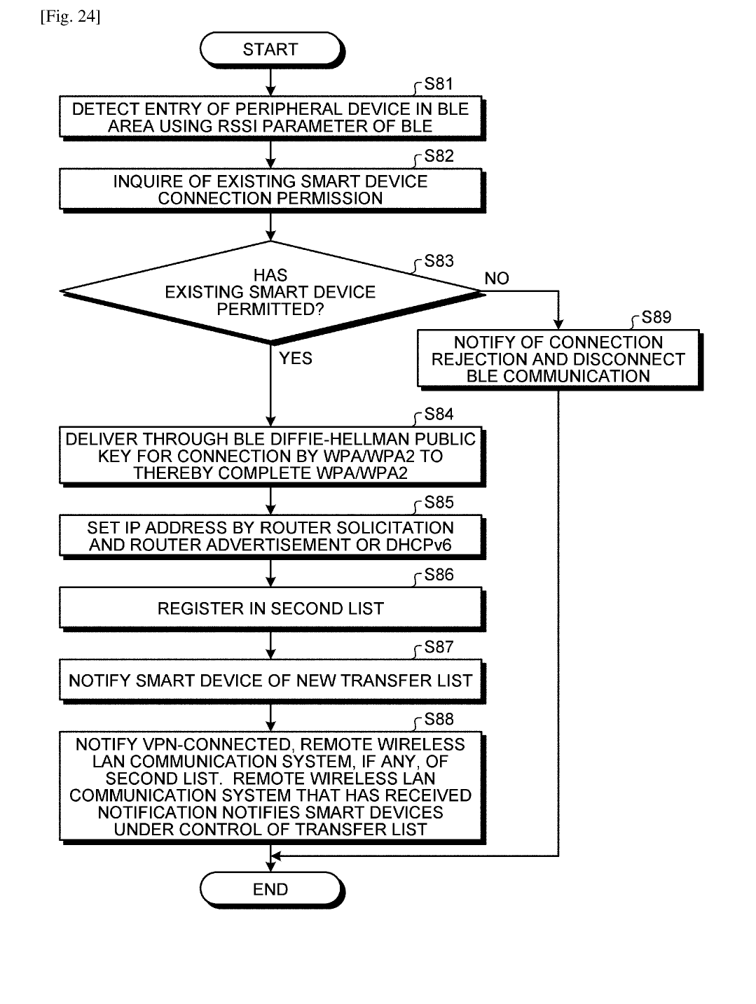

A flowchart illustrated in FIG. 24 illustrates steps to be performed for establishing a wireless LAN communication line connection in the peripheral device such as the printer device 3 that has moved into the BLE communication area 6. As with the smart device, the communication range limiting device 1 uses, for example, received signal strength indication (RSSI parameter) of the BLE communication unit 17 to detect a peripheral device that moves in or out of the BLE communication area 6. At Step S81 of the flowchart illustrated in FIG. 24, the peripheral device connecting module 76 of the communication range limiting device 1 detects movement of a peripheral device to or from the BLE communication area 6 on the basis of the RSSI parameter of the BLE communication unit 17.

The peripheral device connecting module 76 illustrated in FIG. 18, when having detected movement of a peripheral device to or from the BLE communication area 6, inquires, at Step S82, of the first list 91 of the HDD 14 via the memory control module 93 presence of a previously connected smart device. If a previously connected peripheral device exists, the peripheral device connecting module 76 inquires, at Step S83, of the smart device registered in the first list 91 via the BLE communication control module 79 and the BLE communication unit 17 whether a new peripheral device can be connected.

If a response rejecting connection of a new peripheral device is received from the previously connected smart device as a result of the inquiry about whether a new peripheral device can be connected (No at Step S83), the peripheral device connecting module 76 notifies the peripheral device that has been detected to be moved into the BLE communication area 6 of connection rejection via the BLE communication control module 79 and the BLE communication unit 17 at Step S89. The peripheral device connecting module 76 then disconnects the BLE communication with the new peripheral device (the peripheral device that has been rejected for connection by the smart device) that has required connection with the wireless LAN communication line and terminates the steps of the flowchart illustrated in FIG. 24.

It is noted that the step of inquiring of the previously connected smart device the connection of a new peripheral device to thereby obtain permission at Step S82, Step S83, and Step S89 may be omitted.

If a response permitting connection of a new peripheral device is received from the previously connected smart device as a result of the inquiry about whether a new peripheral device can be connected (Yes at Step S83), and if no previously connected smart devices exist (no smart devices are registered in the first list 91), the peripheral device connecting module 76 delivers, at Step S84, a public key according to, for example, the Diffie-Hellman key exchange method to the new peripheral device through BLE communication. It is noted that a PIN code in place of the public key may be delivered. The foregoing step sets up a Wi-Fi wireless communication line by WPA/WPA2 in each of the new peripheral device and the communication range limiting device 1. Then, an IP address (Wi-Fi address) of the new peripheral device is automatically set, so that the new peripheral device is connected to the wireless LAN (Wi-Fi connection).

When the wireless LAN communication line is established with the new peripheral device, the peripheral device connecting module 76 of the communication range limiting device 1 transmits a RS command and receives a RA returned in response to the RS command via the NW I/F 94 to thereby acquire prefix information in the network interface. The peripheral device connecting module 76 next generates, for example, a 128-bit IPv6 address from the acquired prefix information and the interface ID based on the MAC address of the new smart device. The communication range limiting device 1 performs address collision detection for the generated IPv6 address. The communication range limiting device 1, when having detected no address collision, sets the generated IPv6 address as the IPv6 address of the new smart device. It is noted that, at Step S85, the IPv6 address may be set by DHCPv6 in response to user operation.

At Step S86, the memory control module 93 of the communication range limiting device 1 registers the IPv6 address of the new peripheral device set as described above in the second list 92. When the second list 92 is updated as a result of the IPv6 address of the new peripheral device being stored, at Step S87, the peripheral device connecting module 76 generates the transfer list 95 that contains, for example, the type, IP address, and control information of each of the peripheral devices registered in the updated second list 92. The peripheral device connecting module 76 transfers the generated transfer list 95 to each of the smart devices registered in the first list 91 via the BLE communication unit 17.

When another wireless LAN communication system connected by, for example,

VPN connection exists at a physically remote place, the peripheral device connecting module 76 transmits the updated second list 92 to the other wireless LAN communication system. The memory control module 93 of the communication range limiting device 1 of the other wireless LAN communication system updates the second list 92 of the peripheral devices controlled by the other wireless LAN communication system with the reported second list 92. The peripheral device connecting module 76 of the other wireless LAN communication system generates the transfer list 95 that contains, for example, the type, IPv6 address, and control information of each of the peripheral devices registered in the updated second list 92. The peripheral device connecting module 76 of the other wireless LAN communication system transfers the generated transfer list 95 to each of the smart devices registered in the first list 91 of the other wireless LAN communication system via the BLE communication unit 17. This step causes the transfer list 95 registered in each of the smart devices controlled by the other wireless LAN communication system to be updated and the steps of the flowchart illustrated in FIG. 24 are terminated. At Step S84, a PIN code may be delivered in place of the public key.

### Print Operation on Basis of Transfer List

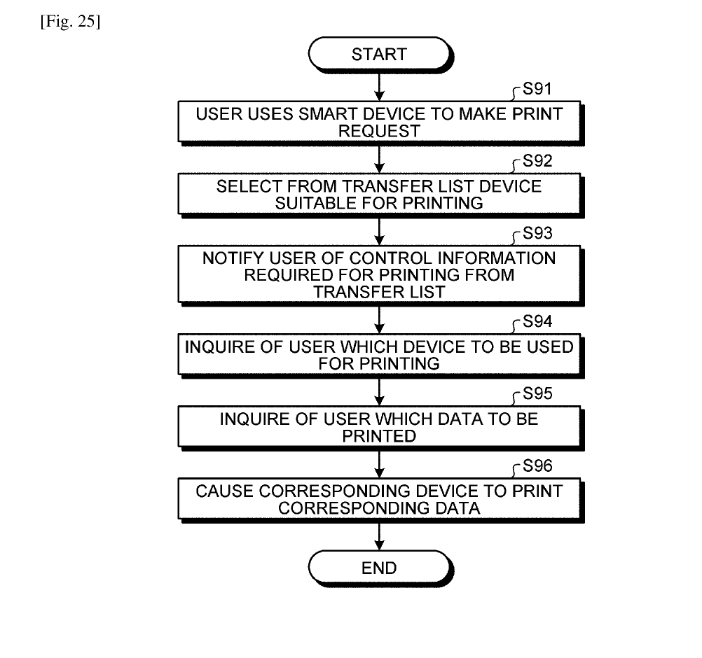

The following describes an exemplary print operation performed by the smartphone 2 on a printer device 3 selected on the basis of the transfer list 95 as an example in which a smart device operates a peripheral device on the basis of the transfer list 95. FIG. 25 is a flowchart illustrating steps of such remote operation.

To print, for example, a desired image or text, the user operates the display unit 24 to make a print request. At Step S91, the CPU 21 of the smartphone 2 illustrated in FIG. 17 acquires the print request from the user. Then, the operation proceeds to Step S92.

At Step S92, the CPU 21 reads information on the type of each peripheral device from the transfer list 95 stored in the RAM 23 and controls to display the type information on the display unit 24. The user selects a specific printer device 3 as the peripheral device suitable for the printing on the basis of the displayed type information. At Step S93, the CPU 21 reads from the transfer list 95 control information of the printer device 3 selected by the user and controls to display the control information on the display unit 24. The CPU 21 then controls to display on the display unit 24 a message that says, for example, “Select the device” at Step S94, thereby prompting the user to select the printer device 3 to be used for printing. The user, by comparing, for example, the control information of each printer device 3, selects the specific printer device 3 to be used for printing.

Upon detecting the operation to select the printer device 3 to be used for printing, the CPU 21 inquires about the data to be printed at Step S95. The user specifies the location at which the data to be printed is stored in the smartphone 2 and the data or file to be printed. This step allows the CPU 21 to recognize the storage location of the print data, data name, and the printer device 3 that is to perform printing. The CPU 21 then transfers, at Step S96, the data specified by the user to the printer device 3 that is to perform the printing and makes a print request for the transferred data. The smartphone 2 located within the BLE communication area 6 thus can remotely operate the printer device 3 located within the BLE communication area 6 to perform printing of the desired data.

### Communication Line Disconnecting Operation

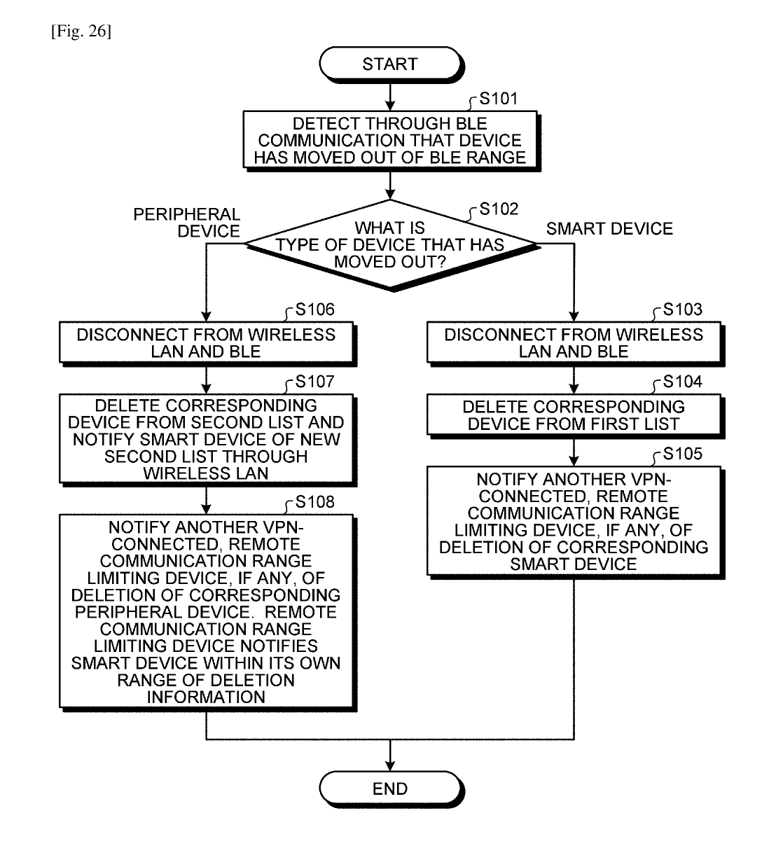

A flowchart illustrated in FIG. 26 illustrates steps of an operation to be performed to disconnect a wireless LAN communication line that has been connected as described above when the smart device and the peripheral device move out of the BLE communication area 6. If reception of a response to the above-described communication range information (see, for example, Step S2) is not detected, the withdrawal detecting module 77 of the communication range limiting device 1 illustrated in FIG. 18 determines, at Step S101, that the device has moved out of the BLE communication area 6. The withdrawal detecting module 77 determines, at Step S102, the type of the device that has moved out of the BLE communication area 6. If the type of the device that has moved out of the BLE communication area 6 is determined to be a smart device, steps from Step S103 to Step S105 are performed. If the type of the device that has moved out of the BLE communication area 6 is determined to be a peripheral device, steps from Step S106 to Step S108 are performed.

When the operation proceeds to Step S103 as a result of the determination that the type of the device that has moved out of the BLE communication area 6 is a smart device, the withdrawal detecting module 77 refers to the first list 91 of the HDD 14 via the memory control module 93. The withdrawal detecting module 77 acquires the wireless LAN IPv6 address that is assigned to the smart device identified by the BLE address that has not returned a response to the communication range information. At Step S103, the wireless LAN AP control module 78 disconnects the wireless LAN communication line for the smart device that corresponds to the acquired IPv6 address.

At Step S104, the memory control module 93 deletes all information relating to the smart device that corresponds to the acquired IPv6 address from the first list 91 to thereby update the first list 91. Specifically, the memory control module 93 deletes information on the smart device that has moved out of the BLE communication area 6 from the first list 91.

If another wireless LAN communication system connected by, for example, VPN connection exists at a physically remote place, the device connecting module 75 notifies at Step S105 the other wireless LAN communication system of the smart device that has moved out of the BLE communication area 6. Specifically, the device connecting module 75 transmits to the other wireless LAN communication system via the NW I/F 94 the first list 91 in which the information on the smart device that has moved out of the BLE communication area 6 has been deleted. This step causes the first list 91 and the transfer list 95 to be updated on the other wireless LAN communication system side. Upon completion of such a notification operation for the other wireless LAN communication system, the steps of the flowchart illustrated in FIG. 26 are terminated.

When the operation proceeds to Step S106 as a result of the determination that the type of the device that has moved out of the BLE communication area 6 is a peripheral device, the withdrawal detecting module 77 refers to the second list 92 of the HDD 14 via the memory control module 93. The withdrawal detecting module 77 acquires the wireless LAN IPv6 address that is assigned to the peripheral device identified by the BLE address that has not returned a response to the communication range information. At Step S106, the wireless LAN AP control module 78 disconnects the wireless LAN communication line for the peripheral device that corresponds to the acquired IPv6 address.

At Step S107, the memory control module 93 deletes all information relating to the peripheral device that corresponds to the acquired IPv6 address from the second list 92 to thereby update the second list 92. The peripheral device connecting module 76 uses the updated second list 92 to regenerate the above-described transfer list 95 and transfers the regenerated transfer list 95 to each of the smart devices registered in the first list 91 (notifies each of the smart devices registered in the first list 91 of the regenerated transfer list 95). This step updates the transfer list 95 of each smart device.

If another wireless LAN communication system connected by, for example, VPN connection exists at a physically remote place, the peripheral device connecting module 76 notifies at Step S108 the other wireless LAN communication system of the peripheral device that has moved out of the BLE communication area 6. Specifically, the peripheral device connecting module 76 transmits to the other wireless LAN communication system via the NW I/F 94 the second list 92 in which the information on the peripheral device that has moved out of the BLE communication area 6 is deleted. This step causes the second list 92 and the transfer list 95 to be updated on the other wireless LAN communication system side. Upon completion of such a notification operation for the other wireless LAN communication system, the steps of the flowchart illustrated in FIG. 26 are terminated.

Connecting Operation for VPN Connection with another Wireless LAN Communication System

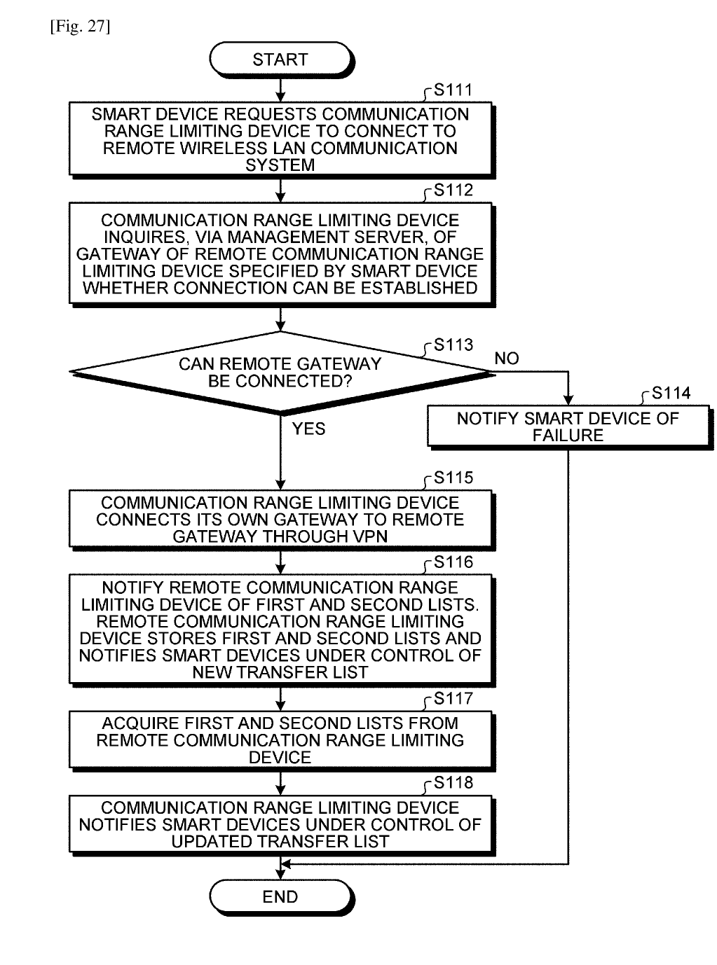

The following describes an operation in which a first wireless LAN communication system and a second wireless LAN communication system that exists at a place physically apart from the first wireless LAN communication system are connected to each other, as illustrated in FIG. 15, via an exclusive external network that is built on a network shared between the first and second wireless LAN communication systems and in which a network address assigned to a particular wireless LAN communication system is not duplicated. Exemplarily, the following describes, with reference to a flowchart illustrated in FIG. 27, an operation for establishing a VPN connection between the first wireless LAN communication system and the second wireless LAN communication system connected to each other via the Internet 100.

Consider, for example, a case in which a user of a smartphone 2 controlled by the first wireless LAN communication system wants to perform, for example, remote control of a peripheral device controlled by the second wireless LAN communication system. In this case, the user refers to the transfer list 95 stored in the smartphone 2. As described previously, the transfer list 95 contains the IPv6 address of the second wireless LAN communication system and the type, IPv6 address, and control information of the peripheral device controlled by the second wireless LAN communication system. The user refers to the IPv6 address of the second wireless LAN communication system, the type information of the peripheral device controlled on the second wireless LAN communication system side, and the like and operates the smartphone 2 to thereby select the second wireless LAN communication system with which the connection is to be established. At Step S111, the smartphone 2 of this user transmits to the communication range limiting device 1 through BLE communication information that indicates the second wireless LAN communication system selected by the user and a connection request to the second wireless LAN communication system.

At Step S112, the peripheral device connecting module 76 of the communication range limiting device 1 illustrated in FIG. 18 inquires, through the management server device 150 illustrated in FIG. 15, of the gateway control module 99 of the second wireless LAN communication system selected by the user whether a VPN connection can be established.

If a response that the VPN connection cannot be established is received from the gateway control module 99 of the second wireless LAN communication system (No at Step S113), the peripheral device connecting module 76 transmits through BLE communication to the smartphone 2 of the user an error message that says that no communication line can be established with the second wireless LAN communication system at Step S114 and the steps of the flowchart illustrated in FIG. 27 are terminated.

In contrast, if a response that the VPN connection can be established is received from the gateway control module 99 of the second wireless LAN communication system (Yes at Step S113), the peripheral device connecting module 76 establishes a VPN connection between gateway modules of the first and second wireless LAN communication systems at Step S115. Specifically, the NW I/F 94 of the communication range limiting device 1 includes a gateway module that is achieved by hardware or software. The peripheral device connecting module 76 establishes a VPN connection between the gateway modules of the first and second wireless LAN communication systems through the gateway control module 99 and the gateway module of the NW I/F 94 of each wireless LAN communication system. This step establishes a connection through a virtual dedicated line between the wireless LAN communication systems connected by a shared line such as the Internet 100.

Then at Step S116, the device connecting module 75 and the peripheral device connecting module 76 transmit the first list 91 and the second list 92 to the second wireless LAN communication system through the VPN. The memory control module 93 of the second wireless LAN communication system uses the received first list 91 and second list 92 to update the old (existing) first list 91 and second list 92 stored in the HDD 14. Additionally, the peripheral device connecting module 76 of the second wireless LAN communication system generates a new transfer list 95 using the received second list 92. The peripheral device connecting module 76 of the second wireless LAN communication system transfers the new transfer list 95 to each of the smart devices controlled in the second wireless LAN communication system. This step updates the transfer list 95 of each smart device in the second wireless LAN communication system.

At Step S117, the device connecting module 75 and the peripheral device connecting module 76 acquire the first list 91 and the second list 92 from the second wireless LAN communication system through the VPN. The memory control module 93 updates the old (existing) first list 91 and second list 92 stored in the HDD 14 using the first list 91 and the second list 92 acquired from the second wireless LAN communication system.

Then at Step S118, the peripheral device connecting module 76 generates a new transfer list 95 from the updated second list 92 and transfers the new transfer list 95 to each of the smart devices controlled by the wireless LAN communication system to which the peripheral device connecting module 76 belongs. This step updates the transfer list 95 of each of the smart devices in the wireless LAN communication system to which the peripheral device connecting module 76 belongs and the steps of the flowchart illustrated in FIG. 27 are terminated.

Disconnecting Operation for VPN Connection with another Wireless LAN Communication System

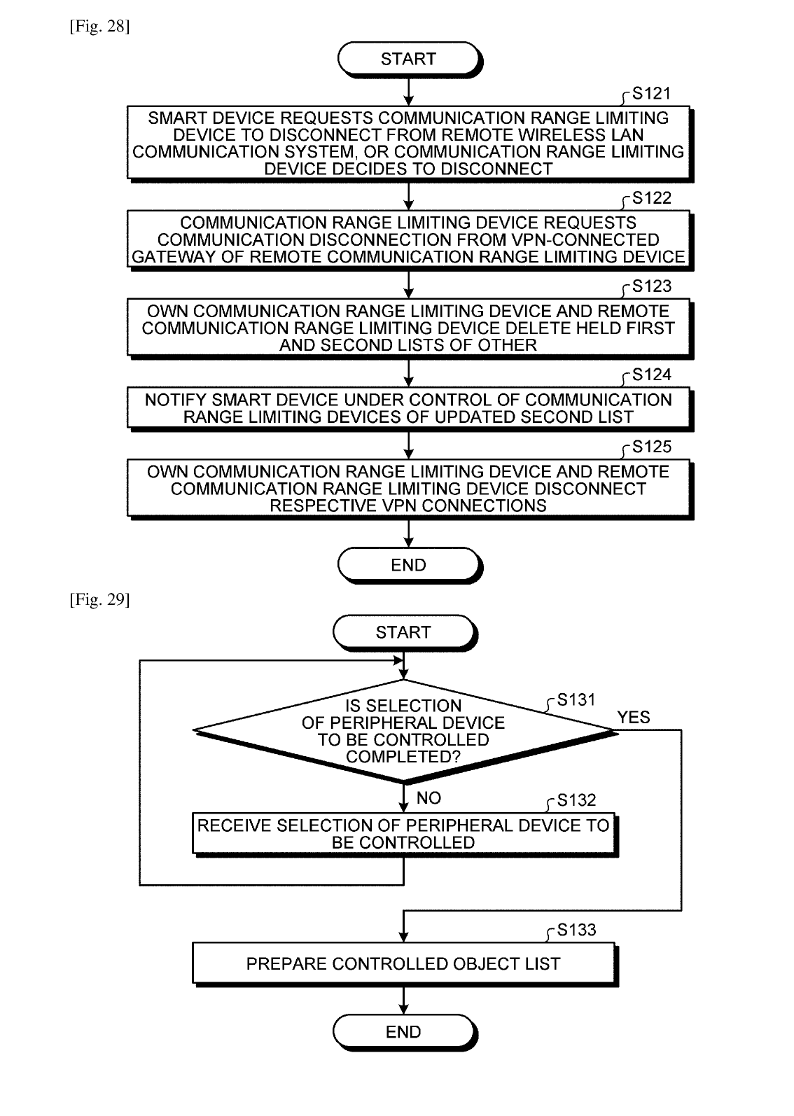

The following describes, with reference to a flowchart illustrated in FIG. 28, an operation to disconnect the VPN connection with another wireless LAN communication system. Consider, for example, a case in which a VPN connection is established between a first wireless LAN communication system and a second wireless LAN communication system and a user of a smartphone 2 controlled by the communication range limiting device 1 of the first wireless LAN communication system wants to disconnect the VPN communication line. In this case, the user uses the transfer list 95 to select the peripheral device of the VPN-connected wireless LAN communication system and performs the communication line disconnecting operation. When this disconnecting operation is detected, the BLE communication control module 83 notifies, at Step S121, the communication range limiting device 1 of the IPv6 address of the wireless LAN communication system to which the peripheral device specified by the user belongs through BLE communication to thereby make a request for disconnecting the VPN communication line (disconnection request function).

The communication range limiting device 1, having received the request for disconnecting the VPN connection line, requests the communication range limiting device 1 of the second wireless LAN communication system via the NW I/F 94 to disconnect the VPN communication line at Step S122.

At Step S123, the communication range limiting device 1 of each of the first and second wireless LAN communication systems deletes from the first list 91 and the second list 92 information on the smart device and the peripheral device that carry the IPv6 address of the other wireless LAN communication system. More specifically, the communication range limiting device 1 of the first wireless LAN communication system deletes from the first list 91 and the second list 92 information on the smart device and the peripheral device that carry the IPv6 address of the second wireless LAN communication system to thereby update the first list 91 and the second list 92. Alternatively, the communication range limiting device 1 of the second wireless LAN communication system deletes from the first list 91 and the second list 92 information on the smart device and the peripheral device that carry the IPv6 address of the first wireless LAN communication system to thereby update the first list 91 and the second list 92.

At Step S124, the communication range limiting device 1 of each of the first and second wireless LAN communication systems uses the updated second list 92 to generate a new transfer list 95 and transfers the new transfer list 95 to the smart devices controlled by the corresponding wireless LAN communication system. This step replaces the transfer list 95 of each smart device with the new transfer list 95 in which the information on the peripheral devices of the other VPN-connected wireless LAN communication system has been deleted.

At Step S125, the communication range limiting device 1 of each of the first and second wireless LAN communication systems causes the router control module 98, the gateway control module 99, and the gateway module of the NW I/F 94 to disconnect the VPN connection. This step terminates the flowchart illustrated in FIG. 28.

The above example has been concerned with the user's making a request for disconnection of the VPN communication line. Nonetheless, the communication range limiting device 1 may determine that the VPN communication line with another wireless LAN communication system is no longer necessary and may be disconnected when all smart devices move out of the BLE communication area 6 and no more smart devices registered in the first list 91 are available.

### Remote Operation of a Plurality of Projector Devices

The following describes a case in which a projector device 4 controlled by a VPN-connected first wireless LAN communication system and a projector device 4 controlled by a VPN-connected second wireless LAN communication system are both remotely operated by a smartphone 2 controlled by the first wireless LAN communication system. It is assumed that the projector device 4 in each of the first wireless LAN communication system and the second wireless LAN communication system is located within the BLE communication area 6 and has been registered in the second list 92.

In this case, the user first prepares a list of projector devices 4 to be controlled (controlled object list). A flowchart illustrated in FIG. 29 depicts steps for preparing the controlled object list. The user operates the smartphone 2 to display the transfer list 95. As described previously, the transfer list 95 serves as a list of peripheral devices controlled by each of the first and second wireless LAN communication systems. The user selects a desired peripheral device from among the peripheral devices listed in the transfer list 95. In this case, the user selects from the transfer list 95 a projector device 4 that is controlled by the first wireless LAN communication system and a projector device 4 that is controlled by the second wireless LAN communication system.

When the selection is completed, the user operates the smartphone 2 to perform a selection completion operation that indicates that the selection has been completed. At Step S131, the CPU 21 of the smartphone 2 monitors whether the selection is completed. Before detecting the selection completion operation (No at Step S131), the CPU 21 accepts an operation to select a desired peripheral device at Step S132. When the selection completion operation is detected (Yes at Step S131), the operation proceeds to Step S133.

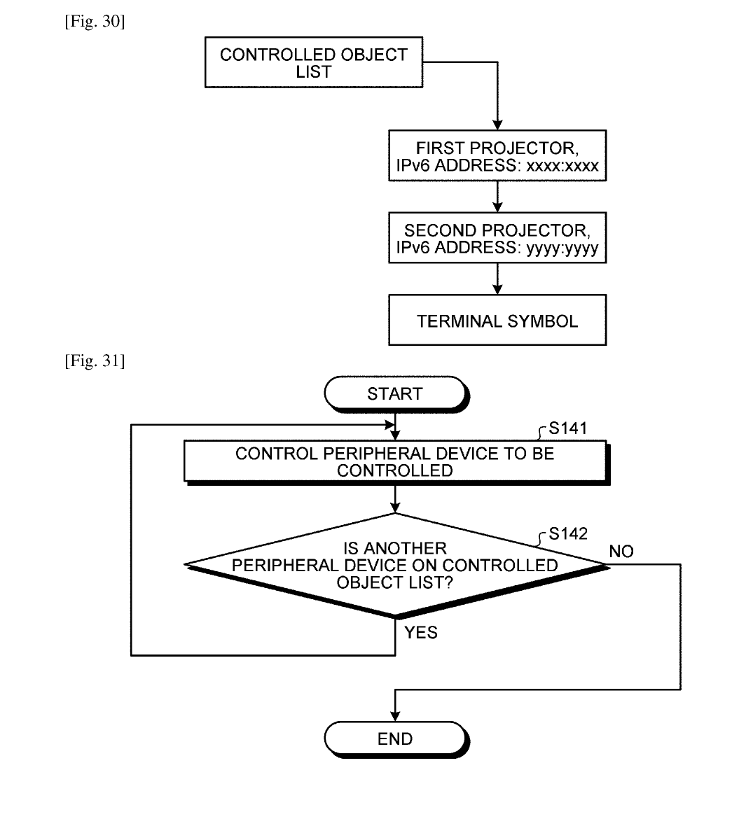

At Step S133, the CPU 21 prepares the controlled object list of the projector devices 4 selected by the user and controls to display the controlled object list on the display unit 24. FIG. 30 illustrates an exemplary controlled object list. The example illustrated in FIG. 30 represents a controlled object list prepared in linked list format. With the linked list format, a series of nodes has any given data field group and one piece or a plurality of pieces of link information points to a subsequent or a preceding node. The example illustrated in FIG. 30 is a list of a first projector device linked to a second projector device. It is noted that the controlled object list may be prepared in, for example, an array format or a tree format, instead of the linked list format.

A flowchart illustrated in FIG. 31 illustrates steps of controlling projection operations for a plurality of projector devices in accordance with the controlled object list. The controlled object list prepared by the smartphone 2 of the user is transmitted to the communication range limiting device 1 through BLE communication and stored in a memory of, for example, the HDD 14 of the communication range limiting device 1. The CPU 11 of the communication range limiting device 1 controls, at Step S141, projection of the first projector device 4 in accordance with the controlled object list that specifies the first projector device 4 first on the list through the wireless LAN communication using the wireless LAN AP unit 16 or the BLE communication using the BLE communication unit 17.

At Step S142, the CPU 11 determines whether another projector device 4 exists on the controlled object list. If no more projector device 4 to be controlled exists, the CPU 11 directly terminates the steps of the flowchart illustrated in FIG. 31.

If a projector device 4 that is controlled by another wireless LAN communication system, for example, exists as the projector device 4 to be controlled next, the CPU 11 accesses the other wireless LAN communication system connected by VPN connection via the NW I/F 94. The CPU 11 then inquires whether the projector device 4 to be next controlled can be controlled. If a response that the projector device 4 to be next controlled cannot be controlled is received, the CPU 11 determines whether still another projector device 4 to be next controlled exists on the third controlled object list.

In contrast, if a response that the projector device 4 to be next controlled can be controlled is received, the CPU 11 returns the operation to Step S141 and controls projection of the second projector device 4 that is controlled by the other wireless LAN communication system.

As described above, the CPU 11 sequentially controls the projector devices and the like to be controlled in accordance with the controlled object list. This arrangement enables control of, for example, causing a projector device of a wireless LAN communication system located in Tokyo and a projector device of a wireless LAN communication system located in Osaka to project an identical image simultaneously.

### Effects of Embodiment

As evident from the foregoing descriptions, the wireless LAN communication system in the embodiment is applied to a configuration in which a plurality of wireless LAN communication systems exist at places that are physically apart from each other, each of the wireless LAN communication systems enabling use of wireless LAN communication only for devices that are located in the BLE communication area 6 within the wireless LAN communication area 5. In this environment, a unique address such as the IPv6 address having a specific prefix is distributed to each of these wireless LAN communication systems and the VPN connection is established between the wireless LAN communication systems. When the VPN connection is established, the wireless LAN communication systems exchange the first list 91 and the second list 92 that indicate the devices located in the BLE communication area 6 of the respective wireless LAN communication systems. Each of the wireless LAN communication systems performs communication control of the devices using the first list 91 and the second list 92 of the devices located in the BLE communication area 6 of the host wireless LAN communication system and the first list 91 and the second list 92 acquired from the remote wireless LAN communication system.

The VPN connection established between the wireless LAN communication systems that exist at places that are physically apart from each other enables enhanced security to be maintained of each wireless LAN communication system. The VPN connection further enables communication between devices existing in the wireless LAN communication systems at places that are physically apart from each other, while securing security of the communication path of each wireless LAN communication system. In addition, when no printer devices exist in a first wireless LAN communication system, a smart device disposed in the first wireless LAN communication system can operate a printer device disposed in a second wireless LAN communication system to, for example, perform printing on the printer device disposed in the second wireless LAN communication system. This capability achieves enhanced convenience of the wireless LAN communication system.

The IPv6 address that is an aggregatable global unicast address and a unique local address is distributed as a network address to each wireless LAN communication system. Because the IPv6 address can generate a plurality of unique addresses, collision of network addresses can be avoided even when VPN connection is established between wireless LAN communication systems.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

For example, in the above descriptions of the embodiment, the BLE communication area 6 using Bluetooth communication is created as the second communication range within the wireless LAN communication area 5. Ultrasonic waves having predetermined frequencies (voice) such as, for example, the ultrasonic wave of a frequency close to those of audible waves may nonetheless be used instead of the Bluetooth communication. In this case, each device outputs ultrasonic waves via a speaker and collects the ultrasonic waves output from other devices.

In this case, the second communication range can be easily adjusted by adjusting the output level of the ultrasonic wave (voice). Additionally, the ultrasonic wave (voice) can be easily shielded. Hence, extremely low possibility of sniffing by third persons.

Optical communication using light having a prescribed wavelength, such as infrared rays and visible rays, may be used in place of the Bluetooth communication. In this case, each device emits light having a prescribed wavelength via a light emitting portion and receives light from other devices via a light receiving portion. In this case, too, the second communication range can be easily adjusted by adjusting the output level of light emitted by the light emitting portion. Additionally, the light can be easily shielded. Hence, extremely low possibility of sniffing by third persons.

The accompanying claims and their equivalents are intended to cover such forms or modifications as would fall within the scope and spirit of the invention.

### REFERENCE SIGNS LIST

1 Communication range limiting device

2 Smartphone

3 Printer device

4 Projector device

5 Wireless LAN communication area

6 BLE communication area

6′ BLE communication area

7 Wireless LAN communication-disabled area

15 Input/output I/F

16 Wireless LAN AP unit

17 BLE communication unit

31 Wireless LAN communication unit

32 BLE communication unit

47 Wireless LAN communication unit

48 BLE communication unit

67 Wireless LAN communication unit

68 BLE communication unit

75 Device connecting module

76 Peripheral device connecting module

77 Withdrawal detecting module

78 Wireless LAN AP control module

79 BLE communication control module

81 Print request module

82 Wireless LAN communication control module

83 BLE communication control module

85 Print module

86 Wireless LAN communication control module

87 BLE communication control module

91 First list

92 Second list

93 Memory control module

94 NW I/F

95 Transfer list

96 Memory control module

98 Router control module

99 Gateway control module

100 Internet

150 Management server device

### CITATION LIST

### Patent Literature

PTL 1: Japanese Laid-open Patent Publication No. 2002-351766

1. A communication device comprising:
a first communication unit that performs wireless communication through a first communication scheme;
a second communication unit that performs wireless communication through a second communication scheme in a second communication range; and
a connecting module configured to establish a communication connection that forms an external network, wherein
the second communication unit transmits setup information for establishing a communication line through the first communication scheme,
the first communication unit performs wireless communication through the first communication scheme with another communication device that has received the setup information, and
the connecting module forms an exclusive external network to establish a communication connection with an external device disposed in a communication system that exists at a physically different place.

2. The communication device according to claim 1, further comprising:
a generating module that generates first information including an address of the other communication device disposed in the second communication range, in the external network;
an acquiring module that acquires second information including an address of the external device in the external network; and
a remote communication control module that controls communication via the external network using the address included in the first information and the address included in the second information.

3. The communication device according to claim 2, wherein
the generating module generates the first information that includes at least a first address for establishing a communication line through the first communication scheme using the setup information, the first address being assigned to the other communication device disposed in the second communication range; a second address for establishing a communication line through the second communication scheme; a type of the external device; and an address of the other communication device for the external network,
the acquiring module acquires, via the external network, the second information generated by the external device, the second information including at least the first address, the second address, the type of the external device, and an address of the external device for the external network, and
the remote communication control module controls communication via the external network between the other communication device indicated by the generated first information and the external device indicated by the acquired second information.

4. The communication device according to claim 3, further comprising:
a withdrawal detecting module that detects movement of the other communication device from an inside of the second communication range to an outside of the second communication range, wherein
when the movement of the other communication device to the outside of the second communication range is detected, the first communication unit refers to the first information, detects the first address assigned to the other communication device that has moved out of the second communication range, and disconnects the wireless communication, through the first communication scheme, of the other communication device that has moved out of the second communication range,
the generating module newly generates the first information in which the first address, the second address, the type of the external device, and the address associated with the other communication device for which the communication by the first communication scheme is disconnected, have been deleted, and
the remote communication control module transmits the newly generated first information to the external device via the external network.

5. The communication device according to claim 3, wherein
the acquiring module acquires, via the external network, new second information transmitted from the external device, and
the generating module updates existing first information with the acquired new second information.

6. The communication device according to claim 3, wherein
the generating module generates the first information that includes control information of the other communication device disposed in the second communication range,
the second communication unit transmits the first information including the control information to another communication device disposed in the second communication range, and transmits, to the other communication device, operation information for operating the other communication device disposed in the second communication range, the operation information being transmitted from the other communication device that has received the first information including the control information; and
the remote communication control module transmits the first information including the control information to the external device via the external network.

7. The communication device according to claim 6, wherein
the acquiring module acquires, via the external network, the first information including the control information transmitted from the external device as second information, and
the generating module updates the existing first information with the acquired second information including the control information.

8. The communication device according to claim 4, wherein the first communication unit disconnects the communication line through the first communication scheme when the other communication device moves out of the second communication range.

9. The communication device according to claim 1, wherein the second communication unit transmits unique identification information or a public key as the setup information to the other communication device.

10. A communication method for a communication device including a first communication unit that performs wireless communication through a first communication scheme; a second communication unit that performs wireless communication through a second communication scheme in a second communication range; and a connecting module configured to establish a communication connection that forms an external network, the communication method comprising:
transmitting, by the second communication unit, setup information for establishing a communication line through the first communication scheme,
performing, by the first communication unit, wireless communication through the first communication scheme with another communication device that has received the setup information, and
forming, by the connecting module, an exclusive external network to establish a communication connection with an external device disposed in a communication system that exists at a physically different place.

11. The communication method according to claim 10, further comprising:
generating, by a generating module, first information including an address of the other communication device disposed in the second communication range, in the external network;
acquiring, by an acquiring module, second information including an address of the other communication device in the external network; and
controlling, by a remote communication control module, remote communication via the external network using the address included in the first information and the address included in the second information.

12. A communication system comprising:
a first communication unit that performs first wireless communication through a first communication scheme;
a second communication unit that performs wireless communication through a second communication scheme in a second communication range; and
a connecting module configured to establish a communication connection that forms an external network, wherein
the second communication unit transmits setup information for establishing a communication line through the first communication scheme,
the first communication unit performs wireless communication through the first communication scheme with another communication device that has received the setup information, and
the connecting module forms an exclusive external network to establish a communication connection with an external device disposed in a communication system that exists at a physically different place.

13. The communication system according to claim 12, further comprising:
a generating module that generates first information including an address of the other communication device disposed in the second communication range, in the external network;
an acquiring module that acquires second information including an address of the other communication device in the external network; and
a remote communication control module that controls communication via the external network using the address included in the first information and the address included in the second information.

14. A computer program product comprising a non-transitory computer-readable medium containing an information processing program, the program causing a computer to function as:
a first communication control module that controls a first communication unit to perform wireless communication through a first communication scheme;
a second communication control module that controls a second communication unit to perform wireless communication through a second communication scheme in a second communication range; and
a connecting module configured to establish a communication connection that forms an external network, wherein
the second communication control module controls the second communication unit to transmit setup information for establishing a communication line through the first communication scheme,
the first communication control module controls the first communication unit to perform wireless communication through the first communication scheme with another communication device that has received the setup information, and
the connecting module forms an exclusive external network to establish a communication connection with an external device disposed in a communication system that exists at a physically different place.
